(19) United States
(12) Patent Application Publication
(10) Pub. No.: US 2026/0223051 A1
(43) Pub. Date: Jul. 30, 2026

(54) D2D POSITIONING SUPPORT MANAGEMENT

(71) Applicant: Telefonaktiebolaget LM Ericsson (publ), Stockholm (SE)

(72) Inventors: Min WANG, Luleå (SE); Ritesh SHREEVASTAV, Upplands Väsby (SE); Xiaolin JIANG, LINKÖPING (SE); Zhang FU, STOCKHOLM (SE)

(73) Assignee: Telefonaktiebolaget LM Ericsson (publ), Stockholm (SE)

(21) Appl. No.: 19/147,088

(22) PCT Filed: Feb. 12, 2024
(86) PCT No.: PCT/EP2024/053486

§ 371 Date: Jul. 10, 2025

Related U.S. Application Data
(60) Provisional application No. 63/445,744, filed on Feb. 15, 2023.

(51) Int. Cl. H04W 64/00; H04W 92/18

(52) U.S. Cl. CPC H04W 64/00; H04W 92/18

(57) ABSTRACT

In some embodiments, a user equipment, UE, may send sidelink, SL, signaling indicating at least one capability of the UE to support positioning of a target UE in a role of an SL positioning server UE and/or in a role of an anchor UE. In further embodiments, a UE may send SL signaling to one or more further UEs. The SL signaling may comprise an indication that the SL signaling has the purpose of discovering at least one UE to support positioning of a target UE in the role of an SL positioning server UE and/or has the purpose of discovering at least one UE to support positioning of the target UE in the role of an anchor UE. Selection of anchor UE and/or a SL positioning server UE may be based on the SL signaling.

### TECHNICAL FIELD

The present disclosure relates to methods for management of support for D2D (Device-to-Device) positioning in a wireless communication system and to corresponding devices, systems, and computer programs.

### BACKGROUND

Current wireless communication networks, e.g., based on the 4th Generation (4G) LTE (Long Term Evolution) or the 5th Generation (5G) NR (New Radio) technology as specified by 3GPP (3rd Generation Partnership Project), provide functionalities for positioning a User Equipment (UE). For example, positioning has been a topic in LTE standardization since 3GPP Release 9. The primary objective is to fulfill regulatory requirements for emergency call positioning. Positioning in NR is proposed to be supported by the architecture shown in FIG. 1, which includes a UE, base stations (or access nodes) denoted as gNB and ng-eNB, an AMF (Access and Mobility Management Function), an LMF (Location Management Function), and optionally an E-SMLC (Evolved Serving Mobile Location Center). The LMF implements functionalities of a location node in the NR technology. There are also interactions between the location node and the gNodeB via the NRPPa protocol. The interaction between the gNodeB and the device is supported via the Radio Resource Control (RRC) protocol.

In the legacy LTE standards, the following techniques are supported:
Enhanced Cell ID: Essentially cell ID information to associate the device to the serving area of a serving cell, and then additional information to determine a finer granularity position.
Assisted GNSS (Global Navigation Satellite System): GNSS information retrieved by the device, supported by assistance information provided to the device from E-SMLC.
OTDOA (Observed Time Difference of Arrival): The device estimates the time difference of reference signals from different base stations and sends to the E-SMLC for multilateration.
UTDOA (Uplink Time Difference of Arrival): The device is requested to transmit a specific waveform that is detected by multiple location measurement units (e.g. an eNB) at known positions. These measurements are forwarded to E-SMLC for multilateration.
Sensor methods such as Biometric pressure sensor which provides vertical position of the device and Inertial Motion Unit (IMU) which provides displacement.

NR supports below RAT Dependent positioning methods:
DL-TDOA (Downlink Time Difference of Arrival): The DL TDOA positioning method makes use of the DL Reference Signal Time Difference (DL RSTD), and optionally Reference Signal Received Power (RSRP) of downlink positioning reference signals (PRS), also denoted as DL PRS RSRP, received from multiple (Transmission Points) TPs, at the UE. The UE measures the DL RSTD, and optionally DL PRS RSRP, of the received signals using assistance data received from the positioning server, and the resulting measurements are used along with other configuration information to locate the UE in relation to the neighboring TPs.
Multi-RTT (Multi-Round-Trip-Time): The Multi-RTT positioning method makes use of the UE Rx-Tx measurements and DL PRS RSRP of downlink signals received from multiple Transmission Reception Points (TRPs), measured by the UE and the measured gNB Rx-Tx measurements and UL SRS-RSRP at multiple TRPs of uplink signals transmitted from UE.
UL-TDOA (Uplink Time Difference of Arrival): The UL TDOA positioning method makes use of the UL TDOA (and optionally UL SRS-RSRP) at multiple Reception Points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.
DL-AoD (Downlink Angle of Departure): The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighbouring TPs.
UL-AoA (Uplink Angle of Arrival): The UL AoA positioning method makes use of the measured azimuth and zenith of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.NR-ECID: NR Enhanced Cell ID (NR E CID) positioning refers to techniques which use additional UE measurements and/or NR radio resource and other measurements to improve the UE location estimate.

The positioning modes can be categorized in below three areas:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.

The LTE and NR technology also support device-to-device (D2D) communication modes to enable direct communication between UEs, sometimes also referred to as sidelink (SL) communication. Such D2D communication modes may for example be used for vehicle communications, e.g., including communication between vehicles, between vehicles and roadside communication infrastructure and, possibly, between vehicles and cellular networks. For the NR technology, sidelink transmissions are specified in 3GPP Release 16. The sidelink transmissions of the NR technology may be regarded as enhancements of the ProSe (PROximity-based SErvices) specified for the LTE technology. The radio interface used for the sidelink modes of the LTE technology and the NR technology is referred to as “PC5” interface. The radio interface used for uplink (UL) and downlink (DL) transmissions between a UE and an access node of the wireless communication network is referred to as “Uu” interface. Enhancements supported for NR sidelink transmissions include:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the QoS (Quality of Service) management is supported in NR sidelink transmissions.

To enable the above enhancements, new physical channels and reference signals are introduced in NR:
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI). The SCI may be regarded as a SL version of DCI (Downlink Control Information).
PSFCH (Physical Sidelink, SL version of PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP (Bandwidth Part). The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

As a further enhancement for 3GPP Release 18, SL positioning is being studied (see 3GPP study item definition RP-213561, 3GPP TSG RAN Meeting #94e, Electronic Meeting, Dec. 6-17, 2021). These studies for example relate to positioning architecture and signaling procedures, e.g., configuration, measurement reporting, etc., and aim at enabling SL positioning covering both UE based and network based positioning, taking into account scenarios with different network coverage, including full coverage (as schematically illustrated in FIG. 2A), partial coverage (as schematically illustrated in FIG. 2B), and out of coverage (as schematically illustrated in FIG. 2C).

In the scenarios of FIG. 2A, FIG. 2B, and FIG. 2C, the UE which is to be positioned is denoted as “target UE”. The “assisting UE” provides SL measurement assistance to the target UE. The assisting UE may be also referred to as a supporting UE. In the illustrated examples, the assisting UE has the role of a reference UE (or anchor UE), which for example acts a sender or receiver of positioning reference signals and/or may provide a position reference by having a known location. Another supporting role in SL positioning is that of a SL positioning server UE, which may for example be responsible for determination of the positioning method to be used, assistance data distribution, reference UE selection, or resource coordination and scheduling. For a target UE out of coverage, there may be different options for the target UE to get positioned. In one option, the target UE may choose to connect to the network via a SL U2N (UE-to-Network) relay UE. In this case, the network can be involved in the positioning procedure for the target UE. In another option, the target UE may apply UE based positioning by involving an assisting UE. If there is not any assisting UE found in the proximity, the target UE can reach an assisting UE in further range via a U2U (UE-to-UE) relay UE.

It is expected that SL positioning uses the same or similar positioning methods as Uu positioning, including DL-TDOA, UL-TDOA, Multi-RTT. In such methods, multiple reference UEs may be required, as schematically illustrated in FIG. 3A and FIG. 3B. FIG. 3A schematically illustrates an example of a positioning method where the target UE receives positioning reference signals from multiple reference UEs and SL positioning is performed on the basis of measurements on these reference signals received by the target UE, such as TDOA. FIG. 3B schematically illustrates an example of a positioning method where the target UE sends positioning reference signals which are received by multiple reference UEs, which in turn provide measurement feedback to the target UE, with SL positioning being performed on the basis of measurements on the measurement feedback, such as Multi-RTT.

For SL positioning, certain method such as TDOA may require tight sync among multiple assisting/reference UEs so that the transmissions of positioning reference signals from these reference UEs can arrive at the target UE in synchronized fashion. This can improve both positioning accuracy and avoid interference among reference UEs

There currently exist certain challenge(s) related to the management and coordination of reference UEs and other supporting UEs in SL positioning. Such challenges are not limited to SL positioning but may also exist in positioning mechanisms which are based on other D2D communication modes. Certain aspects of the disclosure and their embodiments may provide solutions to these or other challenges.

### SUMMARY

According to an embodiment, a method of positioning a target user equipment (UE) is provided. According to the method, the UE sends sidelink (SL) signaling indicating at least one capability of the UE to support positioning of a target UE in a role of an SL positioning server UE and/or in a role of an anchor UE.

According to a further embodiment, a method of positioning a target UE is provided. According to the method, the target UE receives SL signaling from one or more further UEs. The received SL signaling indicates at least one capability of the further UE to support positioning of the target UE in a role of an SL positioning server UE and/or in a role of an anchor UE. Based on the received SL signaling, the target UE selects at least one UE to support positioning of the target UE device.

According to a further embodiment, a method of positioning a target UE is provided. According to the method, a UE sends SL signaling to one or more further UEs. The SL signaling comprises an indication that the SL signaling has the purpose of discovering at least one UE to support positioning of a target UE in the role of an SL positioning server UE and/or has the purpose of discovering at least one UE to support positioning of the target UE in the role of an anchor UE.

According to a further embodiment, a UE is provided. The UE is adapted to send SL signaling indicating at least one capability of the UE to support positioning of a target UE in a role of an SL positioning server UE and/or in a role of an anchor UE.

According to a further embodiment, a UE is provided. The UE comprises processing circuitry and a memory containing program code executable by the processing circuitry. Execution of the program code by the processing circuitry causes the UE to send SL signaling indicating at least one capability of the UE to support positioning of a target UE in a role of an SL positioning server UE and/or in a role of an anchor UE.

According to a further embodiment, a UE is provided. The UE is adapted to receive SL signaling from one or more further UEs. The received SL signaling indicates at least one capability of the further UE to support positioning of the target UE in a role of an SL positioning server UE and/or in a role of an anchor UE. Further, the UE is adapted to, based on the received SL signaling, select at least one UE to support positioning of the UE.

According to a further embodiment, a UE is provided. The UE comprises processing circuitry and a memory containing program code executable by the processing circuitry. Execution of the program code by the processing circuitry causes the UE to receive SL signaling from one or more further UEs. The received SL signaling indicates at least one capability of the further UE to support positioning of the target UE in a role of an SL positioning server UE and/or in a role of an anchor UE. Further, execution of the program code by the processing circuitry causes the UE to, based on the received SL signaling, select at least one UE to support positioning of the UE.

According to a further embodiment, a UE is provided. The UE is adapted to send SL signaling to one or more further UEs. The SL signaling comprises an indication that the SL signaling has the purpose of discovering at least one UE to support positioning of a target UE in the role of an SL positioning server UE and/or has the purpose of discovering at least one UE to support positioning of the target UE in the role of an anchor UE.

According to a further embodiment, a UE is provided. The UE comprises processing circuitry and a memory containing program code executable by the processing circuitry. Execution of the program code by the processing circuitry causes the UE to send SL signaling to one or more further UEs. The SL signaling comprises an indication that the SL signaling has the purpose of discovering at least one UE to support positioning of a target UE in the role of an SL positioning server UE and/or has the purpose of discovering at least one UE to support positioning of the target UE in the role of an anchor UE.

According to a further embodiment, a computer program or computer program product is provided, e.g., in the form of a non-transitory storage medium, which comprises program code to be executed by processing circuitry of a UE. Execution of the program code causes the UE to send SL signaling indicating at least one capability of the UE to support positioning of a target UE in a role of an SL positioning server UE and/or in a role of an anchor UE.

According to a further embodiment, a computer program or computer program product is provided, e.g., in the form of a non-transitory storage medium, which comprises program code to be executed by processing circuitry of a UE. Execution of the program code causes the UE to receive SL signaling from one or more further UEs. The received SL signaling indicates at least one capability of the further UE to support positioning of the target UE in a role of an SL positioning server UE and/or in a role of an anchor UE. Further, the UE is adapted to, based on the received SL signaling, select at least one UE to support positioning of the UE.

According to a further embodiment, a computer program or computer program product is provided, e.g., in the form of a non-transitory storage medium, which comprises program code to be executed by processing circuitry of a UE. Execution of the program code causes the UE to send SL signaling to one or more further UEs. The SL signaling comprises an indication that the SL signaling has the purpose of discovering at least one UE to support positioning of a target UE in the role of an SL positioning server UE and/or has the purpose of discovering at least one UE to support positioning of the target UE in the role of an anchor UE.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 schematically illustrates a positioning architecture of the 3GPP NR technology.

FIGS. 2A. 2B. and 2C illustrate different coverage scenarios of UEs.

FIGS. 3A and 3B. schematically illustrate different methods which may be used for positioning a UE.

FIG. 4 schematically illustrates an example of a communication system in accordance with some embodiments.

FIG. 5 schematically illustrates an example of selecting a SL positioning server UE in accordance with an embodiment.

FIG. 6 illustrates an example of selecting a reference UE in accordance with an embodiment.

FIG. 7 illustrates a further example of selecting a reference UE in accordance with an embodiment.

FIG. 8 shows a flowchart for illustrating a method in accordance with an embodiment.

FIG. 9 shows a flowchart for illustrating a further method in accordance with an embodiment.

FIG. 10 shows a flowchart for illustrating a further method in accordance with an embodiment.

FIG. 11 shows a flowchart for illustrating a further method in accordance with an embodiment.

FIG. 12 shows a flowchart for illustrating a further method in accordance with an embodiment.

FIG. 13 shows a flowchart for illustrating a further method in accordance with an embodiment.

FIG. 14 shows a UE in accordance with some embodiments.

FIG. 15 shows a network node in accordance with some embodiments.

FIG. 16 illustrates an example of a virtualization environment which may be used in the context of some embodiments.

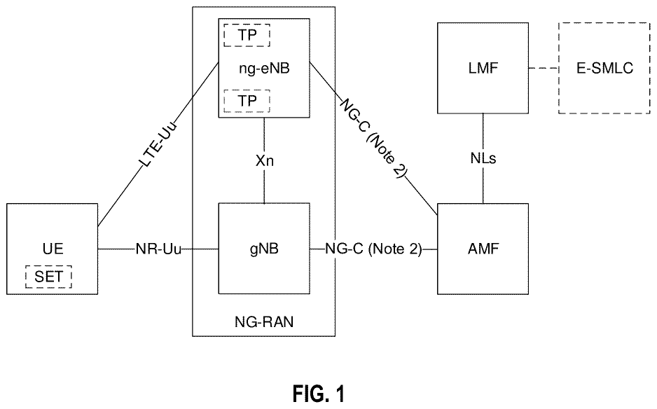

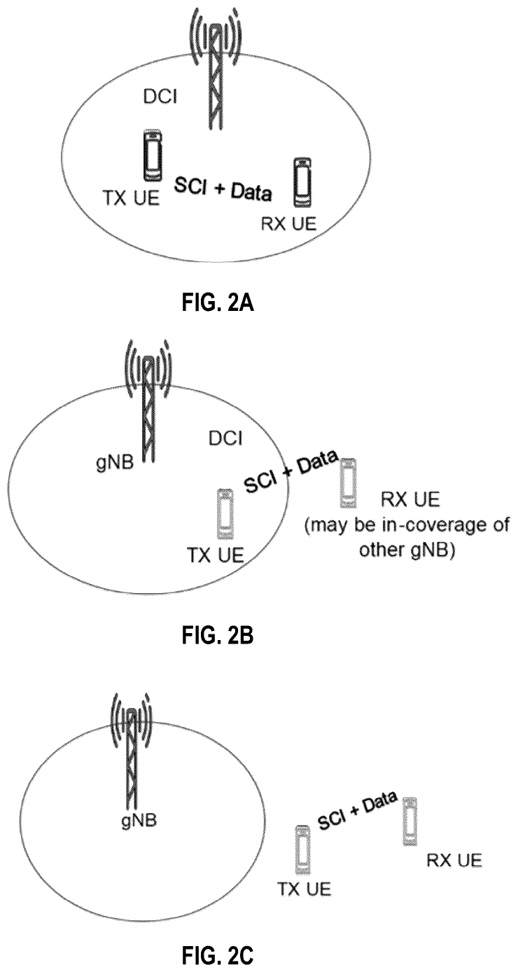

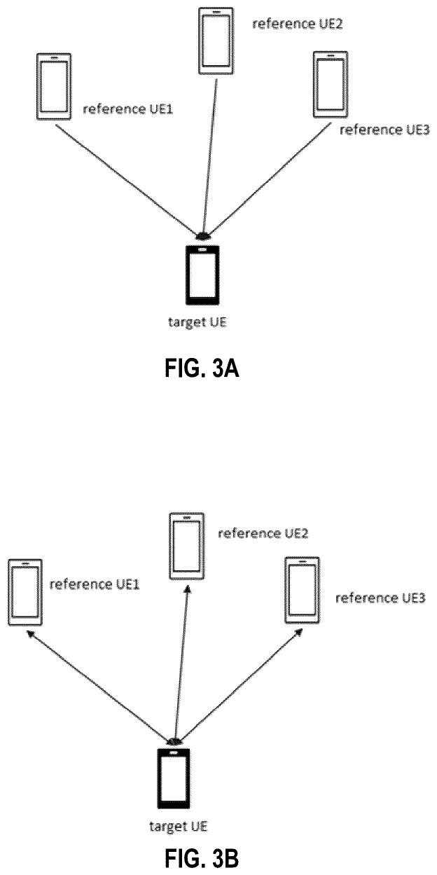

### DETAILED DESCRIPTION

Some of the embodiments contemplated herein will now be described more fully with reference to the accompanying drawings. Embodiments are provided by way of example to convey the scope of the subject matter to those skilled in the art.

Concepts illustrated in the present disclosure aim at enabling efficient selection of one or more D2D communication devices for supporting positioning of a target D2D communication device. The supporting D2D communication device may for example support the positioning in the role of a positioning server. In addition or as an alternative, the supporting D2D communication device may support the positioning in the role of a positioning reference.

As used herein, the term “wireless device” (WD) refers to a device capable, configured, arranged, and/or operable to communicate wirelessly with network nodes and/or other WDs. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a Voice over IP (VOIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, Laptop Embedded Equipment (LEE), Laptop Mounted Equipment (LME), a smart device, a wireless Customer Premise Equipment (CPE), a vehicle mounted wireless terminal device, a connected vehicle, etc. In some examples, in an Internet of Things (IoT) scenario, a WD may also represent a machine or other device that performs monitoring and/or measurements, and transmits the results of such monitoring and/or measurements to another WD and/or a network node. The WD may in this case be a Machine-to-Machine (M2M) device, which may in a 3GPP context be referred to as a Machine-Type Communication (MTC) device. As one particular example, the WD may be a UE implementing the 3GPP Narrowband IoT (NB-IoT) standard. Particular examples of such machines or devices are sensors, metering devices such as power meters, industrial machinery, home or personal appliances (e.g., refrigerators, televisions, etc.), or personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal. The illustrated concepts particularly concern WDs that support D2D communication, for example by implementing a 3GPP standard for SL communication, Vehicle-to-Vehicle (V2V), Vehicle-to-Infrastructure (V2I), Vehicle-to-Everything (V2X). Such WDs supporting D2D communication are herein also denoted as D2D communication devices. The D2D communication may for example be based on the LTE radio technology or the NR radio technology as specified by 3GPP, e.g., on the PC5 interface of the LTE or NR technology. However, it is noted that the illustrated concepts could also be applied to other types of D2D communication technologies and other types of D2D communication devices, e.g., to a WLAN (Wireless Local Area Network) technology or similar wireless ad-hoc network technology, e.g., a vehicular ad-hoc network (VANET).

More specifically, the present disclosure provides methods which may for example enable efficient selection of a SL positioning server UE and/or of a reference UE. For scenarios when multiple candidate SL positioning server UEs are available, the present disclosure may provide mechanisms which may be used by the target UE to filter and/or select an appropriate SL positioning server UE. The target UE may obtain capabilities of one or more candidate SL positioning server UEs along with other information, such as location, speed, battery status and/or RSRP measurements. Based on such information, the target UE may compare the different available candidate SL positioning server UEs and select one of the candidate SL positioning server UEs. Further, the present disclosure provides mechanisms which, once the SL positioning server UE is selected, enable determining one or more reference UEs for the target UE. Mechanisms provided by the present disclosure may also enable the target UE to identify one or more potential reference UEs, with further selection being performed by the SL positioning server UE. Benefits provided by the present disclosure thus include efficient selection of a SL positioning server UE and/or efficient selection of reference UEs.

In some embodiments, a method of positioning a target D2D communication device is provided. According to the method, the target D2D communication device receives D2D signaling from one or more further D2D communication devices. Based on the received D2D signaling, the target D2D communication device selects at least one D2D communication device to support positioning of the target D2D communication device.

In some embodiments, a method of positioning a target D2D communication device is provided. According to the method, a D2D communication device sends D2D signaling indicating at least one capability of the D2D communication device to support positioning of a target D2D communication device. The D2D signaling may enable a target D2D communication device to select at least one D2D communication device to support positioning of the target D2D communication device.

In some embodiments, a network node configures a target D2D communication device to operate according to a method in which the target D2D communication device receives D2D signaling from one or more further D2D communication devices and, based on the received D2D signaling, selects at least one D2D communication device to support positioning of the target D2D communication device.

In some embodiments, a network node configures a D2D communication device to operate according to a method in which the D2D communication device sends D2D signaling indicating at least one capability of the D2D communication device to support positioning of a target D2D communication device. The D2D signaling may enable a target D2D communication device to select at least one D2D communication device to support positioning of the target D2D communication device.

In some embodiments, a D2D communication device is provided. The D2D communication device is adapted to receive D2D signaling from one or more further D2D communication devices. Further, the D2D communication device is adapted to, based on the received D2D signaling, select at least one D2D communication device to support positioning of the D2D communication device. In some embodiments, a D2D communication device is provided. The D2D communication device comprises processing circuitry and a memory. The memory contains program code executable by the processing circuitry, whereby execution of the program code by the processing circuitry causes the D2D communication device to receive D2D signaling from one or more further D2D communication devices. Further, the memory contains program code executable by the processing circuitry, whereby execution of the program code by the processing circuitry causes the D2D communication device to, based on the received D2D signaling, select at least one D2D communication device to support positioning of the D2D communication device.

In some embodiments, a D2D communication device is provided. The D2D communication device is adapted to send D2D signaling indicating at least one capability of the D2D communication device to support positioning of a target D2D communication device. The D2D signaling may enable a target D2D communication device to select at least one D2D communication device to support positioning of the target D2D communication device.

In some embodiments, a D2D communication device is provided. The D2D communication device comprises processing circuitry and a memory. The memory contains program code executable by the processing circuitry, whereby execution of the program code by the processing circuitry causes the D2D communication device to send D2D signaling indicating at least one capability of the D2D communication device to support positioning of a target D2D communication device. The D2D signaling may enable a target D2D communication device to select at least one D2D communication device to support positioning of the target D2D communication device. In some embodiments, a network node is provided. The network node is adapted to configure a target D2D communication device to operate according to a method in which the target D2D communication device receives D2D signaling from one or more further D2D communication devices and, based on the received D2D signaling, selects at least one D2D communication device to support positioning of the target D2D communication device.

In some embodiments, a network node is provided. The network node comprises processing circuitry and a memory. The memory contains program code executable by the processing circuitry, whereby execution of the program code by the processing circuitry causes the network node to configure a target D2D communication device to operate according to a method in which the target D2D communication device receives D2D signaling from one or more further D2D communication devices and, based on the received D2D signaling, selects at least one D2D communication device to support positioning of the target D2D communication device.

In some embodiments, a network node is provided. The network node is adapted to configure a D2D communication device to operate according to a method in which the D2D communication device sends D2D signaling indicating at least one capability of the D2D communication device to support positioning of a target D2D communication device. The D2D signaling may enable a target D2D communication device to select at least one D2D communication device to support positioning of the target D2D communication device.

In some embodiments, a network node is provided. The network node comprises processing circuitry and a memory. The memory contains program code executable by the processing circuitry, whereby execution of the program code by the processing circuitry causes the network node to configure a D2D communication device to operate according to a method in which the D2D communication device sends D2D signaling indicating at least one capability of the D2D communication device to support positioning of a target D2D communication device. The D2D signaling may enable a target D2D communication device to select at least one D2D communication device to support positioning of the target D2D communication device.

In some embodiments, a computer program or computer program product is provided, e.g., in the form of a non-transitory storage medium, which comprises program code to be executed by processing circuitry of a D2D communication device. Execution of the program code causes the D2D communication device to receive D2D signaling from one or more further D2D communication devices. Further, execution of the program code causes the D2D communication device to, based on the received D2D signaling, select at least one D2D communication device to support positioning of the D2D communication device.

In some embodiments, a computer program or computer program product is provided, e.g., in the form of a non-transitory storage medium, which comprises program code to be executed by processing circuitry of a D2D communication device. Execution of the program code causes the D2D communication device to send D2D signaling indicating at least one capability of the D2D communication device to support positioning of a target D2D communication device. The D2D signaling may enable a target D2D communication device to select at least one D2D communication device to support positioning of the target D2D communication device.

In some embodiments, a computer program or computer program product is provided, e.g., in the form of a non-transitory storage medium, which comprises program code to be executed by processing circuitry of a network node. Execution of the program code causes the network node to configure a target D2D communication device to operate according to a method in which the target D2D communication device receives D2D signaling from one or more further D2D communication devices and, based on the received D2D signaling, selects at least one D2D communication device to support positioning of the target D2D communication device.

In some embodiments, a computer program or computer program product is provided, e.g., in the form of a non-transitory storage medium, which comprises program code to be executed by processing circuitry of a network node. Execution of the program code causes the network node to configure a D2D communication device to operate according to a method in which the D2D communication device sends D2D signaling indicating at least one capability of the D2D communication device to support positioning of a target D2D communication device. The D2D signaling may enable a target D2D communication device to select at least one D2D communication device to support positioning of the target D2D communication device.

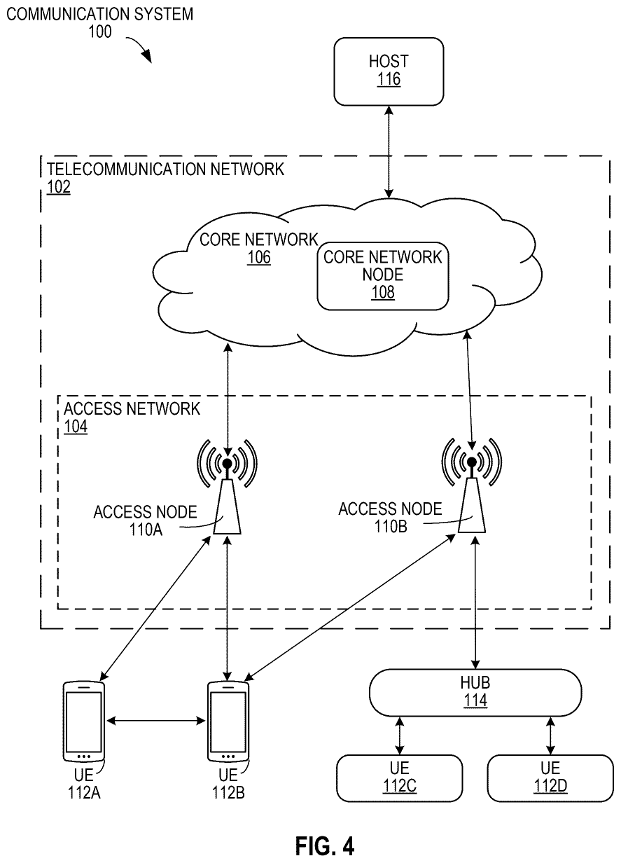

FIG. 4 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile

Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

It is noted that while some of the following description is made in the context of NR, e.g., with the target UE and reference UE(s) being deployed in a same or different NR cell, or with the target UE and/or reference UE(s) being out-of coverage, the link between target UE and an reference UE could be based on LTE sidelink, NR sidelink or any other short-range communication technology such as WLAN. Similarly, a Uu connection between the target UE or the reference UE and a base station could be LTE Uu or NR Uu. Further, it is noted that functionalities as described for an E-SMLC could also be implemented by an LMF and vice versa. At least in some examples, the terms location server, positioning, LMF, E-SMLC may be used inter-changeably.

In the illustrated concepts, SL positioning may involve interaction of UEs which may take different roles when participating in the SL positioning, specifically the role of a SL positioning server UE, the role of an anchor UE (reference UE), and the role of a target UE. Functionalities corresponding to the role of anchor UE may include acting as a sender or receiver of positioning reference signals and/or providing a position reference by having a known location. Functionalities corresponding to the role of a SL positioning server UE may include responsibility for determination of the positioning method to be used, assistance data distribution, anchor UE selection, or resource coordination and scheduling for SL positioning.

An anchor UE may be a UE supporting positioning of target UE, e.g., by transmitting and/or receiving reference signals for positioning, providing positioning-related information, etc. over the SL interface. A target UE may be a UE whose distance, direction and/or position is measured with the support from one or multiple anchor UEs using SL positioning. A SL Positioning Server UE may be a UE offering method determination, assistant data distribution and/or location calculation functionalities for Sidelink Positioning and Ranging based service. The SL positioning server UE may interact with other UEs over PC5 as necessary in order to determine a SL positioning method, distribute assistant data and calculate the location of the target UE. A target UE or anchor UE can act as SL positioning server UE if any of the functionalities is supported.

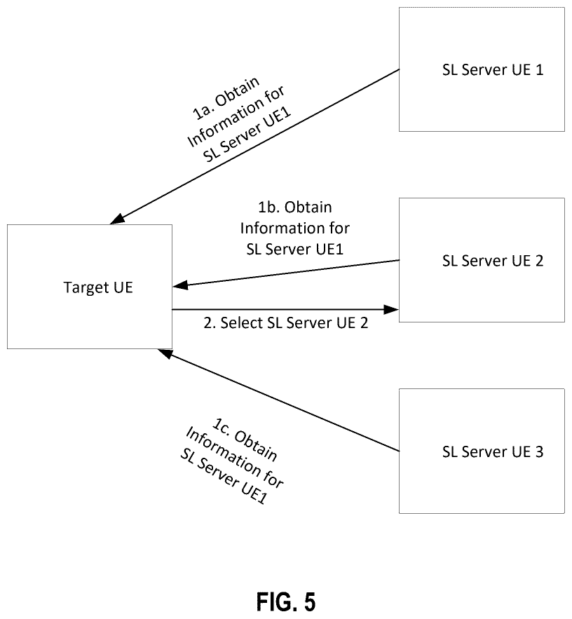

FIG. 5 schematically illustrates an example of selecting a SL positioning server UE in accordance with the illustrated concepts.

Upon triggering of a location request, i.e., a request for positioning of a target UE, the target UE may initiate a discovery procedure to find if there is any SL positioning server UE in the proximity. The discovery procedure may be based on SL signaling sent by the target UE and SL signaling received by the target UE. The SL signaling may be transmitted on SL via unicast, groupcast or broadcast.

The SL signaling sent by the target UE may comprise one or more of the following information:
an indication that the SL signaling has the purpose of discovering one or more SL positioning server UEs. The indication could be a service identifier or code, an explicit bit indicating the purpose, or an implicit indication, such as a specific L2 ID (Layer 2 Identity) assigned to the SL signaling.
one or more positioning QoS requirements such as positioning accuracy, positioning latency, or a transmission reliability requirement for the delivery of positioning measurement results. For example, the transmission of the positioning measurement results to the SL positioning server UE may need to fulfill a required latency bound or transmission reliability requirement.
capabilities of the target UE, e.g., indicating whether the target UE supports SL positioning or what SL positioning method is supported by the target UE. For example, the target UE could support one or more of multi-RTT, TDOA, AoA, or the like, and such capabilities could be indicated by the SL signaling.

In some scenarios, the target UE may select a SL positioning server UE from a list of SL positioning server UE candidates. Such selection may be based on the following criteria or rules:
Selecting the SL positioning server UE with highest PC5 signal strength, e.g., in terms of RSRP (Reference Signal Received Power), RSRQ (Reference Signal Received Quality), or RSSI (Received Signal Strength Indicator).
Selecting the SL positioning server UE with lowest response delay, e.g., by selecting the candidate SL server UE which first provides the response message after the target UE has sent the SL signaling for discovering the SL server UE or selecting a candidate SL positioning server UE whose response delay is below a certain threshold.
Selecting the SL positioning server UE which can be reached by the target UE via a certain maximum number of connection hops, wherein each hop may be a SL connection or a Uu link.
Selecting the SL positioning server UE based on proximity, e.g., by selecting the SL positioning server UE which is closest to the target UE. The distance between the SL server UE and the target UE may be estimated by either the target UE or the server UE. The distance may be included in the response message if the distance is estimated by the server UE.
Selecting the SL positioning server UE based on load, e.g., by selecting the SL positioning server with lowest positioning load. Here, the positioning load may for example be considered in terms of a number of target UEs which are being served by the SL positioning server UE. Alternatively or in addition, the load could be expressed as a volume or percentage of free resources available at the SL server UE to for serving the new target UE. The positioning load may be estimated by the SL server UE and may be included in a response message to the SL signaling sent by the target UE.
Selecting the SL positioning server UE based on battery status, e.g., by selecting the SL positioning server with highest battery status or with battery status above a threshold.
Selecting the SL positioning server UE based on mobility, e.g., by selecting the SL positioning server with lowest relative speed compared to target UE.
Selecting the SL positioning server UE which has discovered most neighbor UEs.
Selecting the SL positioning server UE which has a connection to a network node, e.g., a gNB, a DU (Distributed Unit), a CU (Centralized Unit), an AMF, an LMF, or the like.

Each candidate SL positioning server UE may broadcast its capabilities and functionalities, e.g., in terms of supported positioning methods, measurements and other task that the UE capable of performing in the role of a SL positioning server UE, e.g., distribution of assistance data, scheduling of positioning measurements, resource allocation for positioning measurements or reporting of positioning measurements, or a capability to configure periodic, semi-persistent and aperiodic SL-PRS configurations. The target UE may select the SL positioning server UE based upon the capabilities of discovered candidate SL positioning server UEs.

Further, a candidate SL positioning server UE could also have the capability to support positioning of the target UE in another role. For example, the candidate SL positioning server UE could also be capable of taking the role of a reference UE. Such case, the selecting of the SL positioning server UE could also consider such available additional role. For example, the target UE could select the SL positioning server UE which also supports taking the role of a reference UE in addition to the role of the SL positioning server UE.

Based on the discovery procedure, the target UE may learn a list of candidate SL positioning server UEs. This may be accomplished by adding a candidate server UE to the list when the target UE has received a response message from the candidate SL positioning server UE, indicating that the candidate SL positioning server UE can serve the target UE. Alternatively or in addition, a network node could configure the target UE with one or more candidate SL positioning server UEs. Such network node could be gNB, a DU, a CU, an AMF, or an LMF. Alternatively or in addition, one or more candidate SL positioning server UEs could be preconfigured on the target UE, e.g., based on operator configuration, manufacturer configuration, or standardization. Accordingly, the list of candidate SL positioning server UEs could include one or more learnt candidates, one or more network-configured candidates, and/or one or more preconfigured candidates.

A candidate SL positioning server UE may be removed from the list of candidate SL positioning server UEs when the candidate SL positioning server UE is deemed to be invalid. Such validity decision may be accomplished by the target UE, based on various criteria or rules.

For example, a candidate SL positioning server UE could deemed as valid if the server UE is in the list for less than a certain time period. A validity timer could be defined for each candidate SL positioning server UE. The validity timer may be started when the candidate SL positioning server UE server UE is added to the list. When the validity timer has expired, the candidate SL positioning server UE may be removed from the list.

In addition or as an alternative, a candidate SL positioning server UE may be deemed as invalid if the candidate SL positioning server UE has sent a message to the target UE indicating that the SL positioning server UE will stop serving the target UE or will not be able to serve the target UE, e.g., due to its capacity being reached or due to some other policy.

In addition or as an alternative, a candidate SL positioning server UE may be deemed as invalid if the target UE fails to establish at least one PC5 connection for SL positioning purpose towards the candidate SL positioning server UE or if the candidate SL positioning server UE fails to establish at least one PC5 connection for SL positioning purpose towards the target UE.

In addition or as an alternative, a candidate SL positioning server UE may be deemed as invalid if the target UE fails to maintain a PC5 connection towards the candidate SL positioning server UE for SL positioning purpose, e.g., if an RLF (radio link failure) is triggered on the PC5 connection. In addition or as an alternative, a candidate SL positioning server UE may be deemed as invalid if the server UE has changed its RRC state, or selects a different cell, or performs a handover to a different cell.

In one embodiment, a candidate SL positioning server UE may send SL signaling to its neighbor UEs in unicast, groupcast or broadcast mode, to indicate that the UE is able to act as a SL positioning server UE for one or more other UEs which need to be positioned by SL positioning.

The SL signaling may include one or more of the following:
SL positioning signaling, signaling of a SL positioning protocol.
SL discovery signaling.
non-access stratum signaling on the SL interface, e.g., PC5-S signaling.
RRC signaling on the SL interface.
MAC signaling on the SL interface, e.g., within a MAC CE (MAC Control Element).
L1 (Layer 1) signaling, e.g., a signaling on the PSSCH, such as SCI, or signaling on the PSFCH.

For any one of the above signaling alternatives, the SL signaling may include one or more of the following information:
An indication that the UE is able to act as a SL positioning server UE.
One or more capabilities of the UE, e.g., indicating the SL positioning methods supported as a SL positioning server UE, e.g., multi-RTT, TDOA, AoA, or the like.
An indication whether the SL positioning server UE supports distribution of assistance data for SL positioning
An indication whether the SL positioning server UE supports reference UE selection.

An indication whether the SL positioning server UE supports resource coordination and/or scheduling for SL positioning.

In the example of FIG. 5, candidate SL positioning server UEs are denoted as SL Server UE 1, SL Server UE 2, and SL Server UE 3. In step 1a, the target UE obtains information for SL Server UE 1. In step 1b, the target UE obtains information for SL Server UE 2. In step 1c, the target UE obtains information for SL Server UE 3. These steps may be based on signaling and procedures as described above. At step 2, based on the obtained information, the target UE then selects a SL positioning server UE for serving the target UE, in the illustrated example SL Server UE2. SL positioning for the target UE may then be performed based on interaction of the target UE and SL Server UE 2. Such interaction may for example involve selection of one or more reference UEs for the target UE.

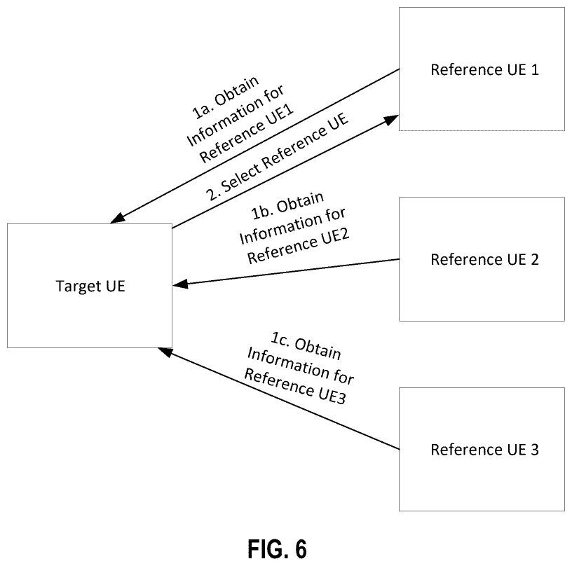

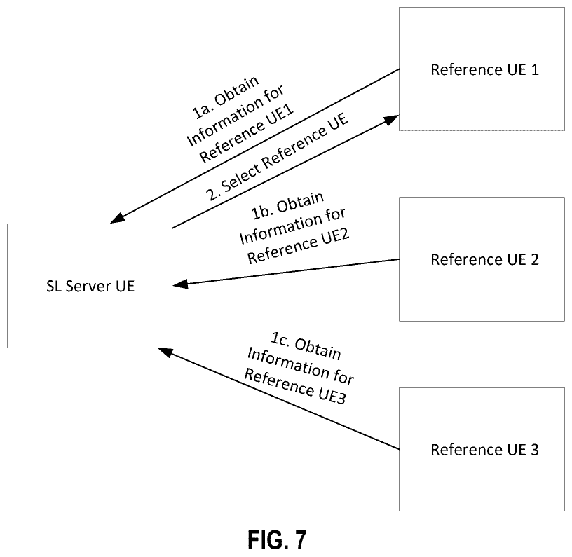

FIG. 6 and FIG. 7 schematically illustrate an example of selecting a reference UE in accordance with the illustrated concepts. Selection of the reference UE may for example be performed subsequently to selection of the SL positioning server UE in accordance with the above principles.

In some scenarios, a UE which is capable of operating as a SL positioning server UE, e.g., each of the above-mentioned candidate SL positioning server UEs, may keep an up-to-date list of the neighboring UEs that are candidate reference UEs. These can be neighboring UEs that fulfil the following conditions:
The neighboring UE is reachable by the SL positioning server UE. For example, the SL positioning server UE could reach the neighboring UE via a direct PC5 connection without involving any relay UE or other node between the SL positioning server UE and the neighboring UE. In addition, the SL positioning server UE could also check if the radio channel quality of the connection to the neighboring UE is sufficient, e.g., above a configured threshold. In some cases, the neighboring UE could be reachable via a multi-hop connection, e.g., via a number of X relay nodes, where each hop may be a SL connection or a Uu link. In such case the SL positioning server UE could also check if the radio channel quality of each hop is sufficient, e.g., above a configured threshold. The SL positioning server UE may calculate an averaged radio channel quality among all hops, and check if the average radio channel quality is above a configured threshold. Alternatively or in addition, the SL positioning server UE could consider whether a transmission initiated by the SL positioning server UE can reach the neighboring UE within a certain time limit.
The neighboring UE can operate as a reference UE, i.e., has the capability of operating as a reference UE for positioning other UEs.

UEs may each build and maintain such list based on exchanging messages with neighbor UEs. In some scenarios, the messages exchanged between the UE and its neighbor UEs may have the purpose of for group discovery. Thit is to say, based on the exchanged messages, each UE may discover potential members of a group for SL positioning purpose. In this case, the UE maintain the list and the neighbor UEs in the list may belong to the same group. The group may be associated with one or multiple specific group IDs which are assigned for SL positioning purpose or for SL positioning services.

In some scenarios, upon triggering of a location request, i.e., a request for positioning a target UE, the target UE may initiate a discovery procedure to find one or more reference UEs. The discovery procedure may be based on SL signaling sent by the target UE and SL signaling received by the target UE. The target UE may then select one or more reference UEs. The selection may be based on one or more of the following rules and criteria:
Selecting the reference UE with strongest PC5 signal strength, e.g., in terms of RSRP, RSRQ, RSSI.
Selecting the reference UE with lowest response delay, e.g., by selecting the reference UE which first provides a response message after the target UE has sent the SL signaling for discovering the reference UE.
Selecting the reference UE based on proximity, e.g., by selecting the reference UE which is closest to the target UE in the proximity. The distance between the reference UE and the target UE may be estimated by either the target UE or the reference UE. If the distance is estimated by the reference UE, the distance may be included in the response message.
Select the reference UE based on positioning load, e.g., by selecting the reference UE with lowest positioning load. Here, the positioning load may be considered in terms of a number of target UEs which are being served by the reference UE, e.g., in terms of a number of target UEs to which the reference UE sends PRS or a number of target UEs from which the reference UE receives and evaluates PRS. In addition or as an alternative, the positioning load could also be considered in terms of a volume or percentage of free resources available at the reference UE to serve the new target UE. If the load is estimated by the reference UE, the load may be included in the response message if the load is estimated by the reference UE.
Selecting the reference UE based on supported SL positioning methods, e.g., by selecting the reference UE that support most SL positioning methods that are also supported by the target UE, e.g., multi-RTT, TDOA, AoA, or the like.
Selecting the reference UE based on the neighbor list of the target UE's SL positioning server UE, e.g., by selecting a UE which is on the neighbor UE list of the SL positioning server UE. For this purpose, the target UE may obtain the list of the neighbor UEs of the SL positioning server UE from the positioning server UE before to initiating the procedure to discover reference UEs. Alternatively or in addition, the target UE may send a message to the SL positioning server UE for checking if a certain reference UE would be reachable by the SL positioning server UE. Upon receiving such message, the SL positioning server UE can check if the reference UE is on its neighbor UE list. The SL positioning server UE can then inform the target UE of the result of the check.

In the example of FIG. 6, candidate reference UEs are denoted as Reference UE 1, Reference UE 2, and Reference UE 3. In step 1a, the target UE obtains information for Reference UE 1. In step 1b, the target UE obtains information for Reference UE 2. In step 1c, the target UE obtains information for Reference UE 3. These steps may be based on signaling and procedures as described above. At step 2, based on the obtained information, the target UE then selects a Reference UE, in the illustrated example Reference UE 1. SL positioning for the target UE may then be performed based on interaction of the target UE and Reference UE 1. Such interaction may for example involve transmission of PRS and or measurement reports. It is noted that when the target UE needs to select multiple reference UEs, the selection process may be iterated for each reference UE to be selected, or multiple reference UEs could be selected by expanding the above rules to a number of N reference UEs to be selected, e.g., by selecting the N reference UEs which have the strongest PC5 signal strength.

In some scenarios, upon triggering of a location request, i.e., a request for positioning a target UE, the target UE may initiate a discovery procedure to find one or more reference UEs, with assistance of the SL positioning server UE. In addition to or as an alternative to selecting the reference UEs by itself, the target UE may send SL signaling to the SL positioning server UE, indicating the need of discovering or selecting one or more reference UEs. The SL signaling sent by the target UE may include one or more of the following information:
One or more IDs of the target UE.
An indication of the need of discovering reference UEs.
An indication of the signaling purpose, i.e., discovery of reference UE(s).
A list of the potential reference UEs discovered by the target UE, optionally including IDs of each reference UE.
Measured signal strengths between the target UE and the potential reference UE, e.g., in terms of RSRP, RSRQ, RSSI, or the like.

Upon receiving such information from the target UE, the SL positioning server UE may select one or more reference UEs for the target UE. This may be accomplished based on the same rules and criteria as explained above for the selection of reference UEs by the target UE itself. The SL positioning server UE may then informs the target UE about the selected reference UEs. For example, the SL positioning server UE may first perform a coarse range estimation with the target UE and also with the candidate reference UEs. Based upon the best proximity between target UE and the candidate reference UE; the SL positioning server UE may then decide the selection of the reference UE.

In the example of FIG. 7, candidate reference UEs are denoted as Reference UE 1, Reference UE 2, and Reference UE 3. The SL positioning server UE is denoted as SL Server UE. In step 1a, the SL positioning server UE obtains information for Reference UE 1. In step 1b, the SL positioning server UE obtains information for Reference UE 2. In step 1c, the SL positioning server UE obtains information for Reference UE 3. These steps may be based on signaling and procedures as described above. At step 2, based on the obtained information, the SL positioning server UE then selects a Reference UE for the target UE, in the illustrated example Reference UE 1 and informs the target UE accordingly. SL positioning for the target UE may then be performed based on interaction of the target UE, Reference UE 1, and the SL positioning server UE. Such interaction may for example involve transmission of PRS and or measurement reports. It is noted that when the target UE needs to select multiple reference UEs, the selection process may be iterated for each reference UE to be selected, or multiple reference UEs could be selected by expanding the above rules to a number of N reference UEs to be selected, e.g., by selecting the N reference UEs which have the strongest PC5 signal strength.

In any one of the above examples, the SL signaling exchanged between two UEs, e.g., between a target UE and a reference UE, between a target UE and a SL positioning server UE, or between a reference UE and a SL positioning server UE, may involve one or more of the following:
SL positioning signaling, i.e., signaling of a SL positioning protocol.
SL discovery signaling.
non-access stratum signaling on the SL interface, e.g., PC5-S signaling.
RRC signaling on the SL interface.
MAC signaling on the SL interface, e.g., within a MAC CE (MAC Control Element).
L1 signaling, e.g., a signaling on the PSSCH, such as SCI, or signaling on the PSFCH.

If SL signaling is used by a target UE to discover another UE to support SL positioning, e.g., a SL positioning server UE or a reference UE, the SL signaling may include an indication of the purpose of the SL signaling, e.g., that the SL signaling is initiated to discover a SL positioning server UE or that the SL the signaling is initiated to discover a reference UE.

If SL signaling is used by a SL positioning server UE to discover another UE, e.g., a neighbor UE which is reachable by the SL positioning server UE and is a potential target UE or a potential reference UE, the SL signaling may to include an indication of the purpose of the SL signaling, e.g., that the purpose is to discover a reachable reference UE, to discover a reachable target UE, or to discover a reachable neighbor UE which may be a reference UE or a target UE.

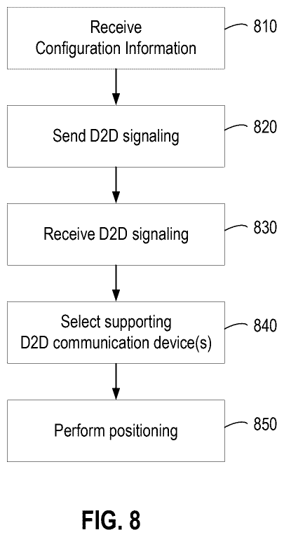

FIG. 8 shows a flowchart for illustrating a method, which may be utilized for implementing the illustrated concepts. The method of FIG. 8 may be used for implementing the illustrated concepts in a target D2D communication device, e.g., corresponding to the target UE in the above examples. The target UE may for example correspond to any of the above-mentioned UEs 112, 112A, 112B, 112C, 112D. The D2D communication device may support D2D communication based on a SL interface of the NR technology. However, other D2D communication technologies could be supported in addition or as an alternative.

If a processor-based implementation of the D2D communication device is used, at least some of the steps of the method of FIG. 8 may be performed and/or controlled by one or more processors of the D2D communication device. Such D2D communication device may also include a memory storing program code for implementing at least some of the below described functionalities or steps of the method of FIG. 8.

At step 810, the target D2D communication device may receive configuration information. At least part of the configuration information may be signaled in system information provided by a network node of the wireless communication system, e.g., from an access node, such as of the wireless communication system, such as one of the above-mentioned access nodes 110, 110b, 110a. Alternatively or in addition, at least part of the configuration information may be signaled in RRC signaling from a network node of the wireless communication system, e.g., from an access node, such as of the wireless communication system, such as one of the above-mentioned access nodes 110, 110a, 110b. Alternatively or in addition, at least part of the configuration information may be signaled in a MAC CE. Alternatively or in addition, at least part of the configuration information may be signaled in a paging message. Alternatively or in addition, at least part of the configuration information may be signaled in a control data packet. Alternatively or in addition, wherein at least part of the configuration information is signaled on a physical layer control channel, e.g., a PDCCH or a PSCCH. The configuration information could thus be signaled by DCI or SCI. Alternatively or in addition, at least part of the configuration information may be signaled via a D2D communication device acting as a relay node.

At step 820, the target D2D communication device may send D2D signaling, i.e., signaling based on the D2D communication technology supported by the target D2D communication device. The sent D2D signaling may include an indication that the D2D signaling has the purpose of discovering at least one D2D communication device to support positioning of the target D2D communication device. Alternatively or in addition, the sent D2D signaling may indicate one or more quality requirements for the positioning of the target D2D communication device, e.g., in terms of positioning accuracy, positioning latency, and/or reliability. Alternatively or in addition, the sent D2D signaling may indicate one or more capabilities of the target D2D communication device. The one or more capabilities may for example include one or more D2D positioning methods supported by the target D2D communication device. If the D2D communication is based on a SL interface of the NR technology. The D2D signaling of step 820 may include one or more of SL positioning signaling, SL discovery signaling, non-access stratum signaling via the SL interface, radio resource control, RRC, signaling via the SL interface, Medium Access Control, MAC, signaling via the SL interface, and SL physical layer signaling.

At step 830, the target D2D communication device receives D2D signaling from one or more further D2D communication devices, i.e., signaling based on the D2D communication technology supported by the target D2D communication device. In some scenarios, the target D2D communication device may receive the D2D signaling in response to the D2D signaling sent at step 820. If the D2D communication is based on a SL interface of the NR technology, the D2D signaling of step 830 may include one or more of SL positioning signaling, SL discovery signaling, non-access stratum signaling via the SL interface, radio resource control, RRC, signaling via the SL interface, Medium Access Control, MAC, signaling via the SL interface, and SL physical layer signaling.

At step 840, based on the received D2D signaling, the target D2D communication device selects at least one D2D communication device to support positioning of the target D2D communication device. The selected at least one D2D communication device may for example include a D2D communication device to support the positioning of the target D2D communication device by acting as a positioning server, such as the above-mentioned SL positioning server UE. As alternative or in addition, the selected at least one D2D communication device may include at least one D2D communication device to support the positioning of the target D2D communication device by acting as a positioning reference, such as the above-mentioned reference UE(s).

If the selected at least one D2D communication device comprises a D2D communication device to support the positioning of the target D2D communication device by acting as a positioning server, the target D2D communication device may select the D2D communication device to act as a positioning server based on signal strength from one or more candidate D2D communication devices. Alternatively or in addition, the target D2D communication device may select the D2D communication device to act as a positioning server based on response delay from one or more candidate D2D communication devices. Alternatively or in addition, the target D2D communication device may select the D2D communication device to act as a positioning server based on a number of hops of a connection from the target D2D communication device to one or more candidate D2D communication devices. Alternatively or in addition, the target D2D communication device may select the D2D communication device to act as a positioning server based on distance between the target D2D communication device and one or more candidate D2D communication devices. Alternatively or in addition, the target D2D communication device may select the D2D communication device to act as a positioning server based on positioning related load of one or more candidate D2D communication devices. Alternatively or in addition, the target D2D communication device may select the D2D communication device to act as a positioning server based on battery status of one or more candidate D2D communication devices. Alternatively or in addition, the target D2D communication device may select the D2D communication device to act as a positioning server based on mobility of one or more candidate D2D communication devices. Alternatively or in addition, the target D2D communication device may select the D2D communication device to act as a positioning server based on a number of neighboring D2D communication devices discovered by each of one or more candidate D2D communication devices. Alternatively or in addition, the target D2D communication device may select the D2D communication device to act as a positioning server based on whether a candidate D2D communication device has a connection to a network node. Alternatively or in addition, the target D2D communication device may select the D2D communication device to act as a positioning server based on whether a candidate D2D communication device is capable of supporting positioning of the target D2D communication device in one or more further roles than a positioning server. The one or more further roles may involve support of positioning of the target D2D communication device by acting as a positioning reference.

If the selected at least one D2D communication device includes at least one D2D communication device to support the positioning of the target D2D communication device by acting as a positioning reference, the target D2D communication device may select the D2D communication device to act as a positioning reference based on signal strength from one or more candidate D2D communication devices. Alternatively or in addition, the target D2D communication device may select the D2D communication device to act as a positioning reference based on response delay from one or more candidate D2D communication devices. Alternatively or in addition, the target D2D communication device may select the D2D communication device to act as a positioning reference based on distance between the target D2D communication device and one or more candidate D2D communication devices. Alternatively or in addition, the target D2D communication device may select the D2D communication device to act as a positioning reference based on positioning related load of one or more candidate D2D communication devices. Alternatively or in addition, the target D2D communication device may select the D2D communication device to act as a positioning reference based on one or more positioning methods respectively supported by the one or more candidate D2D communication devices. Alternatively or in addition, the target D2D communication device may select the D2D communication device to act as a positioning reference based on a set of neighboring D2D communication devices of a D2D communication device supporting positioning of the target D2D communication device as a positioning server. Alternatively or in addition, the target D2D communication device may select the D2D communication device to act as a positioning reference based on whether a candidate device is part of a set of neighboring D2D communication devices of a D2D communication device supporting positioning of the target D2D communication device as a positioning server. The target D2D communication device may receiving an indication of the set of neighboring D2D communication devices from the D2D communication device supporting positioning of the target D2D communication device as a positioning server. For example, the set may be indicated in terms of a list. Alternatively or in addition, the target D2D communication device may enquire the D2D communication device supporting positioning of the target D2D communication device as a positioning server whether a candidate D2D communication device is part of the set of neighboring D2D communication devices.

In some scenarios, the target D2D communication device may select the D2D communication device to act as the positioning server from a set of one or more candidate D2D communication devices, e.g., maintained in a list. The target D2D communication device may determine at least one candidate D2D communication device to act as the positioning server based on the D2D signaling received by the target D2D communication device. Alternatively or in addition, the target D2D communication device may determine at least one candidate D2D communication device to act as the positioning server based on configuration information provided by a network node. Alternatively or in addition, the target D2D communication device may determine at least one candidate D2D communication device to act as the positioning server based on preconfiguration of the target D2D communication device.

At step 850, the target D2D communication device may perform positioning to determine the position of the target D2D communication device, e.g., in terms of geographical coordinates and/or in terms of other indications of physical location. In some scenarios, step 850 may involve that the target D2D communication device sends, to the D2D communication device selected to act as positioning server, a request to select one or more D2D communication devices to act as positioning reference for the target D2D communication device.

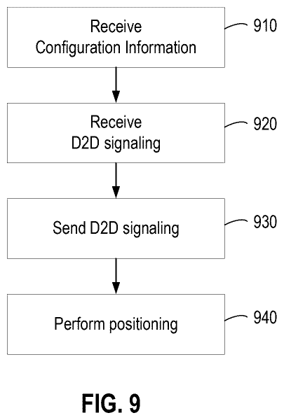

FIG. 9 shows a flowchart for illustrating a further method, which may be utilized for implementing the illustrated concepts. The method of FIG. 9 may be used for implementing the illustrated concepts in a D2D communication device which may support D2D positioning of another D2D communication device, e.g., corresponding to the SL positioning server UE or to the reference UE in the above examples. Such SL positioning server UE or reference UE may for example correspond to any of the above-mentioned UEs 112, 112A, 112B, 112C, 112D. The D2D communication device may support D2D communication based on a SL interface of the NR technology. However, other D2D communication technologies could be supported in addition or as an alternative.

If a processor-based implementation of the D2D communication device is used, at least some of the steps of the method of FIG. 9 may be performed and/or controlled by one or more processors of the D2D communication device. Such D2D communication device may also include a memory storing program code for implementing at least some of the below described functionalities or steps of the method of FIG. 9.

At step 910, the D2D communication device may receive configuration information. At least part of the configuration information may be signaled in system information provided by a network node of the wireless communication system, e.g., from an access node, such as of the wireless communication system, such as one of the above-mentioned access nodes 110, 110a, 110b. Alternatively or in addition, at least part of the configuration information may be signaled in RRC signaling from a network node of the wireless communication system, e.g., from an access node, such as of the wireless communication system, such as one of the above-mentioned access nodes 110, 110a, 110b. Alternatively or in addition, at least part of the configuration information may be signaled in a MAC CE. Alternatively or in addition, at least part of the configuration information may be signaled in a paging message. Alternatively or in addition, at least part of the configuration information may be signaled in a control data packet. Alternatively or in addition, wherein at least part of the configuration information is signaled on a physical layer control channel, e.g., a PDCCH or a PSCCH. The configuration information could thus be signaled by DCI or SCI. Alternatively or in addition, at least part of the configuration information may be signaled via a D2D communication device acting as a relay node.

At step 920, the D2D communication device may receive D2D signaling from a target D2D communication device, i.e., signaling based on the D2D communication technology supported by the D2D communication device. The received D2D signaling may include an indication that the D2D signaling has the purpose of discovering at least one D2D communication device to support positioning of the target D2D communication device. Alternatively or in addition, the received D2D signaling may indicate one or more quality requirements for the positioning of the target D2D communication device, e.g., in terms of positioning accuracy, positioning latency, and/or reliability. Alternatively or in addition, the received D2D signaling may indicate one or more capabilities of the target D2D communication device. The one or more capabilities may for example include one or more D2D positioning methods supported by the target D2D communication device. If the D2D communication is based on a SL interface of the NR technology. The D2D signaling of step 920 may include one or more of SL positioning signaling, SL discovery signaling, non-access stratum signaling via the SL interface, radio resource control, RRC, signaling via the SL interface, Medium Access Control, MAC, signaling via the SL interface, and SL physical layer signaling.

At step 930, the D2D communication device sends D2D signaling, i.e., signaling based on the D2D communication technology supported by the D2D communication device. In some scenarios, the D2D communication device may send the D2D signaling in response to the D2D signaling received at step 920. If the D2D communication is based on a SL interface of the NR technology, the D2D signaling of step 930 may include one or more of SL positioning signaling, SL discovery signaling, non-access stratum signaling via the SL interface, radio resource control, RRC, signaling via the SL interface, Medium Access Control, MAC, signaling via the SL interface, and SL physical layer signaling. The D2D signaling of step 930 indicates at least one capability of the D2D communication device to support positioning of a target D2D communication device. In some scenarios, the at least one capability of the D2D communication device comprises a capability to act as a positioning server. Further, the D2D signaling sent by the D2D communication device may indicate whether the D2D communication device is capable of supporting positioning of the target D2D communication device in one or more further roles than a positioning server. The one or more further roles may include support of positioning of the target D2D communication device by acting as a positioning reference. Alternatively or in addition, the at least one capability of the D2D communication device may include a capability to act as a positioning reference. The D2D signaling sent by the D2D communication device may also indicate one or more positioning methods supported by the D2D communication device.

The D2D signaling sent by the D2D communication device may enable the target D2D communication device to determine a signal strength from the D2D communication device. Alternatively or in addition, the D2D signaling sent by the D2D communication device may enable the target D2D communication device to determine a response delay from the D2D communication device. Alternatively or in addition, the D2D signaling sent by the D2D communication device may enable the target D2D communication device to determine a number of hops of a connection from the target D2D communication device to the D2D communication device. Alternatively or in addition, the D2D signaling sent by the D2D communication device may enable the target D2D communication device to determine a distance between the target D2D communication device and the D2D communication device. Alternatively or in addition, the D2D signaling sent by the D2D communication device may enable the target D2D communication device to determine mobility of the D2D communication device.

In some scenarios, the D2D signaling sent by the D2D communication device may indicate a positioning related load of the D2D communication device. Alternatively or in addition, the D2D signaling sent by the D2D communication device indicates battery status of the D2D communication device. Alternatively or in addition, the D2D signaling sent by the D2D communication device may indicate neighboring D2D communication devices discovered the D2D communication device. Alternatively or in addition, the D2D signaling sent by the D2D communication device may indicate a number of the neighboring D2D communication devices discovered the D2D communication device. Further, the D2D signaling sent by the D2D communication device may indicate respective positioning related capabilities of the neighboring D2D communication devices discovered the D2D communication device. Alternatively or in addition, the D2D signaling sent by the D2D communication device may indicate whether the D2D communication device has a connection to a network node.

At step 940, the D2D communication device may perform or at least support positioning to determine the position of the target D2D communication device, e.g., in terms of geographical coordinates and/or in terms of other indications of physical location. For example, the D2D communication device may support the positioning by acting as a positioning server and/or by acting as a positioning reference. In some scenarios, step 940 may involve that, in response to being selected to act as positioning server, the D2D communication device receives, from the target D2D communication device, a request to select one or more D2D communication devices to act as positioning reference for the target D2D communication device. In response to the request, the D2D communication device may select at least one D2D communication device to act as positioning reference for the target D2D communication device. The D2D communication device may then indicate the selected D2D communication device(s) to the target D2D communication device.

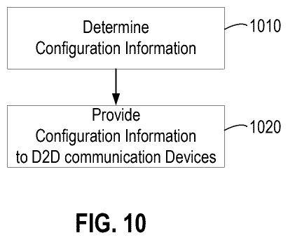

FIG. 10 shows a flowchart for illustrating a further method, which may be utilized for implementing the illustrated concepts. The method of FIG. 10 may be used for implementing the illustrated concepts in a network node, e.g., in an access node, base station, or control node. The network node may for example correspond to one of the above-mentioned access nodes 110, 110a, 110b, AMF, LMF, or E-SMLC. In the method of FIG. 10, the network node configures one or more D2D communication devices to operate according to the method of FIG. 8 or according to the method of FIG. 9. Such D2D communication device correspond to any of the above-mentioned UEs 112, 112a, 112b and may support D2D communication based on a SL interface of the NR technology. However, other D2D communication technologies could be supported in addition or as an alternative.

If a processor-based implementation of the network node is used, at least some of the steps of the method of FIG. 10 may be performed and/or controlled by one or more processors of the network node. Such network node may also include a memory storing program code for implementing at least some of the below described functionalities or steps of the method of FIG. 10.

At step 1010, the network node may determine configuration information. The configuration information has the purpose of configuring the D2D communication device to perform the method of FIG. 8 or the method of FIG. 9. The configuration information may include parameters and/or instructions to be executed by the configured D2D communication device. The configuration information may correspond to the configuration information of step 810 or to the configuration information of step 910.

At step 1020, the network node may provide the configuration information to the D2D communication device(s). For this purpose, the network node may at least temporarily have network connectivity to the D2D communication device(s). At least part of the configuration information may be signaled in system information. Alternatively or in addition, at least part of the configuration information may be signaled in RRC signaling. Alternatively or in addition, at least part of the configuration information may be signaled in a MAC CE. Alternatively or in addition, at least part of the configuration information may be signaled in a paging message. Alternatively or in addition, at least part of the configuration information may be signaled in a control data packet. Alternatively or in addition, wherein at least part of the configuration information is signaled on a physical layer control channel, e.g., a PDCCH or a PSCCH. The configuration information could thus be signaled by DCI or SCI. Alternatively or in addition, at least part of the configuration information may be signaled via a D2D communication device acting as a relay node.

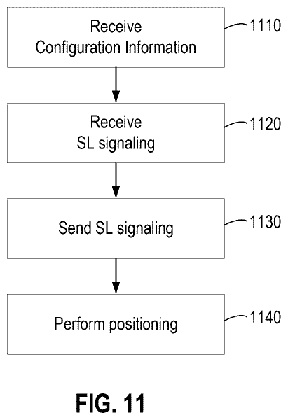

FIG. 11 shows a flowchart for illustrating a further method, which may be utilized for implementing the illustrated concepts. The method of FIG. 11 may be used for implementing the illustrated concepts in a UE which may support SL positioning of another UE, e.g., corresponding to the SL positioning server UE or to the anchor UE (i.e., reference UE) in the above examples. Such SL positioning server UE or reference UE may for example correspond to any of the above-mentioned UEs 112, 112A, 112B, 112C, 112D. The UE may support SL communication based on a SL interface of the NR technology. However, other SL communication technologies could be supported in addition or as an alternative, e.g., SL communication on an SL interface of the LTE technology.

If a processor-based implementation of the UE is used, at least some of the steps of the method of FIG. 11 may be performed and/or controlled by one or more processors of the UE. Such UE may also include a memory storing program code for implementing at least some of the below described functionalities or steps of the method of FIG. 11.

At step 1110, the UE may receive configuration information. At least part of the configuration information may be signaled in system information provided by a network node of the wireless communication system, e.g., from an access node, such as of the wireless communication system, such as one of the above-mentioned access nodes 110, 110a, 110b. Alternatively or in addition, at least part of the configuration information may be signaled in RRC signaling from a network node of the wireless communication system, e.g., from an access node, such as of the wireless communication system, such as one of the above-mentioned access nodes 110, 110a, 110b.

Alternatively or in addition, at least part of the configuration information may be signaled in a MAC CE. Alternatively or in addition, at least part of the configuration information may be signaled in a paging message. Alternatively or in addition, at least part of the configuration information may be signaled in a control data packet. Alternatively or in addition, wherein at least part of the configuration information is signaled on a physical layer control channel, e.g., a PDCCH or a PSCCH. The configuration information could thus be signaled by DCI or SCI. Alternatively or in addition, at least part of the configuration information may be signaled via a UE acting as a relay node.

At step 1120, the UE may receive SL signaling from a target UE. The received SL signaling may include an indication that the SL signaling has the purpose of discovering at least one SL communication device to support positioning of the target UE. Alternatively or in addition, the received SL signaling may indicate one or more quality requirements for the positioning of the target UE, e.g., in terms of positioning accuracy, positioning latency, and/or reliability. Alternatively or in addition, the received SL signaling may indicate one or more capabilities of the target UE. The one or more capabilities may for example include one or more SL positioning methods supported by the target UE. The SL signaling of step 1120 may include one or more of: SL positioning signaling, SL discovery signaling, non-access stratum signaling via the SL interface, radio resource control, RRC, signaling via the SL interface, Medium Access Control, MAC, signaling via the SL interface, and SL physical layer signaling.

At step 1130, the UE sends SL signaling. In some scenarios, the UE may send the SL signaling in response to the SL signaling received at step 1120. The SL signaling of step 1130 may include one or more of: SL positioning signaling, SL discovery signaling, non-access stratum signaling via the SL interface, radio resource control, RRC, signaling via the SL interface, Medium Access Control, MAC, signaling via the SL interface, and SL physical layer signaling. The SL signaling of step 1130 indicates at least one capability of the UE to support positioning of a target UE in the role of a SL positioning server and/or in the role of an anchor UE. The capability information may thus indicate supported roles of the UE in SL positioning. The SL signaling sent by the UE may also indicate one or more positioning methods supported by the UE.

In some scenarios, the SL signaling sent by the UE may enable the target UE to determine a signal strength from the UE. Alternatively or in addition, the SL signaling sent by the UE may enable the target UE to determine a response delay from the UE. Alternatively or in addition, the SL signaling sent by the UE may enable the target UE to determine a number of hops of a connection from the target UE to the UE. Alternatively or in addition, the SL signaling sent by the UE may enable the target UE to determine a distance between the target UE and the UE. Alternatively or in addition, the SL signaling sent by the UE may enable the target UE to determine mobility of the UE.

In some scenarios, the SL signaling sent by the UE may indicate a positioning related load of the UE. Alternatively or in addition, the SL signaling sent by the UE may indicate battery status of the UE. Alternatively or in addition, the SL signaling sent by the UE may indicate neighboring UEs discovered the UE. Alternatively or in addition, the SL signaling sent by the UE may indicate a number of the neighboring UEs discovered the UE. Further, the SL signaling sent by the UE may indicate respective positioning related capabilities of the neighboring UEs discovered the UE. Alternatively or in addition, the SL signaling sent by the UE may indicate whether the UE has a connection to a network node.

At step 1140, the UE may perform or at least support positioning to determine the position of the target UE, e.g., in terms of geographical coordinates and/or in terms of other indications of physical location. For example, the UE may support the positioning by acting as a SL positioning server UE and/or by acting as an anchor UE. In some scenarios, step 1140 may involve that, in response to being selected to act as SL positioning server UE, the UE receives, from the target UE, a request to select one or more UEs to act as anchor UE for the target UE. In response to the request, the UE may select at least one UE to act as anchor UE for the target UE. The UE may then indicate the selected UE(s) to the target UE.

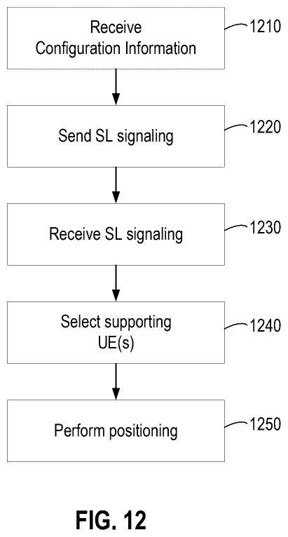

FIG. 12 shows a flowchart for illustrating a further method, which may be utilized for implementing the illustrated concepts. The method of FIG. 12 may be used for implementing the illustrated concepts in a target UE, e.g., corresponding to the target UE in the above examples. The target UE may for example correspond to any of the above-mentioned UEs 112, 112A, 112B, 112C, 112D. The target UE may support SL communication based on a SL interface of the NR technology. However, other SL communication technologies could be supported in addition or as an alternative, e.g., SL communication on an SL interface of the LTE technology.

If a processor-based implementation of the target UE is used, at least some of the steps of the method of FIG. 12 may be performed and/or controlled by one or more processors of the target UE. Such target UE may also include a memory storing program code for implementing at least some of the below described functionalities or steps of the method of FIG. 12.

At step 1210, the target UE may receive configuration information. At least part of the configuration information may be signaled in system information provided by a network node of the wireless communication system, e.g., from an access node, such as of the wireless communication system, such as one of the above-mentioned access nodes 110, 110b, 110a. Alternatively or in addition, at least part of the configuration information may be signaled in RRC signaling from a network node of the wireless communication system, e.g., from an access node, such as of the wireless communication system, such as one of the above-mentioned access nodes 110, 110a, 110b. Alternatively or in addition, at least part of the configuration information may be signaled in a MAC CE. Alternatively or in addition, at least part of the configuration information may be signaled in a paging message. Alternatively or in addition, at least part of the configuration information may be signaled in a control data packet. Alternatively or in addition, wherein at least part of the configuration information is signaled on a physical layer control channel, e.g., a PDCCH or a PSCCH. The configuration information could thus be signaled by DCI or SCI. Alternatively or in addition, at least part of the configuration information may be signaled via a UE acting as a relay node.

At step 1220, the target UE may send SL signaling. The sent SL signaling may include an indication that the SL signaling has the purpose of discovering at least one UE to support positioning of the target UE. Alternatively or in addition, the sent SL signaling may indicate one or more quality requirements for the positioning of the target UE, e.g., in terms of positioning accuracy, positioning latency, and/or reliability. Alternatively or in addition, the sent SL signaling may indicate one or more capabilities of the target UE. The one or more capabilities may for example include one or more SL positioning methods supported by the target UE. The SL signaling of step 1220 may include one or more of SL positioning signaling, SL discovery signaling, non-access stratum signaling via the SL interface, radio resource control, RRC, signaling via the SL interface, Medium Access Control, MAC, signaling via the SL interface, and SL physical layer signaling.

At step 1230, the target UE receives SL signaling from one or more further UEs. In some scenarios, the target UE may receive the SL signaling in response to the SL signaling sent at step 1220. The SL signaling of step 1230 may include one or more of SL positioning signaling, SL discovery signaling, non-access stratum signaling via the SL interface, radio resource control, RRC, signaling via the SL interface, Medium Access Control, MAC, signaling via the SL interface, and SL physical layer signaling. The received SL signaling indicates at least one capability of the further UE to support positioning of the target UE in a role of an SL positioning server UE and/or in a role of an anchor UE.

At step 1240, based on the received SL signaling, the target UE selects at least one UE to support positioning of the target UE. The selected at least one UE may for example include a UE to support the positioning of the target UE in the role of a SL positioning server UE. As alternative or in addition, the selected at least one UE may include at least one UE to support the positioning of the target UE by acting as an anchor UE, such as the above-mentioned reference UE(s).

If the selected at least one UE comprises a UE to support the positioning of the target UE in the role of a SL positioning server UE, the target UE may select the UE to act as a SL positioning server UE based on signal strength from one or more candidate UEs. Alternatively or in addition, the target UE may select the UE to act as a SL positioning server UE based on response delay from one or more candidate UEs. Alternatively or in addition, the target UE may select the UE to act as a SL positioning server UE based on a number of hops of a connection from the target UE to one or more candidate UEs. Alternatively or in addition, the target UE may select the UE to act as a SL positioning server UE based on distance between the target UE and one or more candidate UEs. Alternatively or in addition, the target UE may select the UE to act as a SL positioning server UE based on positioning related load of one or more candidate UEs. Alternatively or in addition, the target UE may select the UE to act as a SL positioning server UE based on battery status of one or more candidate UEs. Alternatively or in addition, the target UE may select the UE to act as a SL positioning server UE based on mobility of one or more candidate UEs. Alternatively or in addition, the target UE may select the UE to act as a SL positioning server UE based on a number of neighboring UEs discovered by each of one or more candidate UEs. Alternatively or in addition, the target UE may select the UE to act as a SL positioning server UE based on whether a candidate UE has a connection to a network node. Alternatively or in addition, the target UE may select the UE to act as a SL positioning server UE based on whether a candidate UE is capable of supporting positioning of the target UE in one or more further roles than as a SL positioning server UE. The one or more further roles may include the role of an anchor UE.

If the selected at least one UE includes at least one UE to support the positioning of the target UE in the role of an anchor UE, the target UE may select the UE to act as an anchor UE based on signal strength from one or more candidate UEs. Alternatively or in addition, the target UE may select the UE to act as an anchor UE based on response delay from one or more candidate UEs. Alternatively or in addition, the target UE may select the UE to act as an anchor UE based on distance between the target UE and one or more candidate UEs. Alternatively or in addition, the target UE may select the UE to act as an anchor UE based on positioning related load of one or more candidate UEs. Alternatively or in addition, the target UE may select the UE to act as an anchor UE based on one or more positioning methods respectively supported by the one or more candidate UEs. Alternatively or in addition, the target UE may select the UE to act as an anchor UE based on a set of neighboring UEs of a UE supporting positioning of the target UE in the role of a SL positioning server UE. Alternatively or in addition, the target UE may select the UE to act as an anchor UE based on whether a candidate UE is part of a set of neighboring UEs of a UE supporting positioning of the target UE in the role of a SL positioning server UE. The target UE may receive an indication of the set of neighboring UEs from the UE supporting positioning of the target UE in the role of a SL positioning server UE. For example, the set may be indicated in terms of a list. Alternatively or in addition, the target UE may enquire the UE supporting positioning of the target UE in the role of a SL positioning server UE whether a candidate UE is part of the set of neighboring UEs.

In some scenarios, the target UE may select the UE to act as the SL positioning server UE from a set of one or more candidate UEs, e.g., maintained in a list. The target UE may determine at least one candidate UE to act as the SL positioning server UE based on the SL signaling received by the target UE. Alternatively or in addition, the target UE may determine at least one candidate UE to act as the SL positioning server UE based on configuration information provided by a network node. Alternatively or in addition, the target UE may determine at least one candidate UE to act as the SL positioning server UE based on preconfiguration of the target UE.

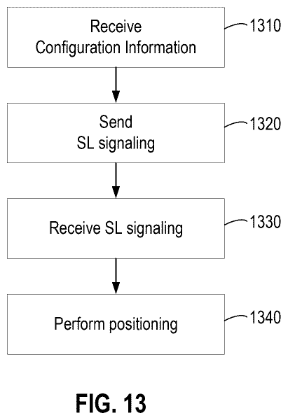

At step 1250, the target UE may perform positioning to determine the position of the target UE, e.g., in terms of geographical coordinates and/or in terms of other indications of physical location. In some scenarios, step 1250 may involve that the target UE sends, to the UE selected to act as SL positioning server UE, a request to select one or more UEs to act as anchor UE for the target UE. FIG. 13 shows a flowchart for illustrating a further method, which may be utilized for implementing the illustrated concepts. The method of FIG. 13 may be used for implementing the illustrated concepts in a UE which may support SL positioning of another UE, e.g., corresponding to the SL positioning server UE or to the anchor UE (i.e., reference UE) in the above examples, or in a target UE. Such target UE, SL positioning server UE, or anchor UE may for example correspond to any of the above-mentioned UEs 112, 112A, 112B, 112C, 112D. The UE may support SL communication based on a SL interface of the NR technology. However, other SL communication technologies could be supported in addition or as an alternative, e.g., SL communication on an SL interface of the LTE technology.

If a processor-based implementation of the UE is used, at least some of the steps of the method of FIG. 13 may be performed and/or controlled by one or more processors of the UE. Such UE may also include a memory storing program code for implementing at least some of the below described functionalities or steps of the method of FIG. 13.

At step 1310, the UE may receive configuration information. At least part of the configuration information may be signaled in system information provided by a network node of the wireless communication system, e.g., from an access node, such as of the wireless communication system, such as one of the above-mentioned access nodes 110, 110a, 110b. Alternatively or in addition, at least part of the configuration information may be signaled in RRC signaling from a network node of the wireless communication system, e.g., from an access node, such as of the wireless communication system, such as one of the above-mentioned access nodes 110, 110a, 110b. Alternatively or in addition, at least part of the configuration information may be signaled in a MAC CE. Alternatively or in addition, at least part of the configuration information may be signaled in a paging message. Alternatively or in addition, at least part of the configuration information may be signaled in a control data packet. Alternatively or in addition, wherein at least part of the configuration information is signaled on a physical layer control channel, e.g., a PDCCH or a PSCCH. The configuration information could thus be signaled by DCI or SCI. Alternatively or in addition, at least part of the configuration information may be signaled via a UE acting as a relay node.

At step 1320, the UE sends SL signaling. The SL signaling of step 1320 may include one or more of: SL positioning signaling, SL discovery signaling, non-access stratum signaling via the SL interface, radio resource control, RRC, signaling via the SL interface, Medium Access Control, MAC, signaling via the SL interface, and SL physical layer signaling. The received SL signaling includes an indication that the SL signaling has the purpose of discovering at least one SL communication device to support positioning of the target UE in the role of a SL positioning server UE and/or the purpose of discovering at least one SL communication device to support positioning of the target UE in the role of an anchor UE. Alternatively or in addition, the received SL signaling may indicate one or more quality requirements for the positioning of the target UE, e.g., in terms of positioning accuracy, positioning latency, and/or reliability. Alternatively or in addition, the received SL signaling may indicate one or more capabilities of the target UE. The one or more capabilities may for example include one or more SL positioning methods supported by the target UE. The SL signaling of step 1320 may also indicate at least one capability of the UE to support positioning of a target UE, e.g., in the role of a SL positioning server and/or in the role of an anchor UE. The capability information may thus indicate supported roles of the UE in SL positioning. The SL signaling sent by the UE may also indicate one or more positioning methods supported by the UE.

In some scenarios, the SL signaling sent by the UE may indicate a positioning related load of the UE. Alternatively or in addition, the SL signaling sent by the UE may indicate battery status of the UE. Alternatively or in addition, the SL signaling sent by the UE may indicate neighboring UEs discovered the UE. Alternatively or in addition, the SL signaling sent by the UE may indicate a number of the neighboring UEs discovered the UE. Further, the SL signaling sent by the UE may indicate respective positioning related capabilities of the neighboring UEs discovered the UE. Alternatively or in addition, the SL signaling sent by the UE may indicate whether the UE has a connection to a network node.

At step 1330, the UE may receive SL signaling from a target UE. In some scenarios, the UE may receive the SL signaling in response to the SL signaling sent at step 1320. The SL signaling of step 1330 may include one or more of: SL positioning signaling, SL discovery signaling, non-access stratum signaling via the SL interface, radio resource control, RRC, signaling via the SL interface, Medium Access Control, MAC, signaling via the SL interface, and SL physical layer signaling. The SL signaling received at step 1330 may indicate at least one capability of further the UE to support positioning of a target UE in the role of a SL positioning server and/or in the role of an anchor UE. The capability information may thus indicate supported roles of the further UE in SL positioning. The SL signaling received by the UE may also indicate one or more positioning methods supported by the UE.

In some scenarios, the SL signaling received by the UE may indicate a positioning related load of the further UE. Alternatively or in addition, the SL signaling sent by the further UE may indicate battery status of the further UE. Alternatively or in addition, the SL signaling received by the UE may indicate neighboring UEs discovered the further UE. Alternatively or in addition, the SL signaling received by the UE may indicate a number of the neighboring UEs discovered the further UE. Further, the SL signaling received by the UE may indicate respective positioning related capabilities of the neighboring UEs discovered the further UE. Alternatively or in addition, the SL signaling received by the UE may indicate whether the further UE has a connection to a network node.

At step 1340, the UE may perform or at least support positioning to determine the position of the target UE, e.g., in terms of geographical coordinates and/or in terms of other indications of physical location.

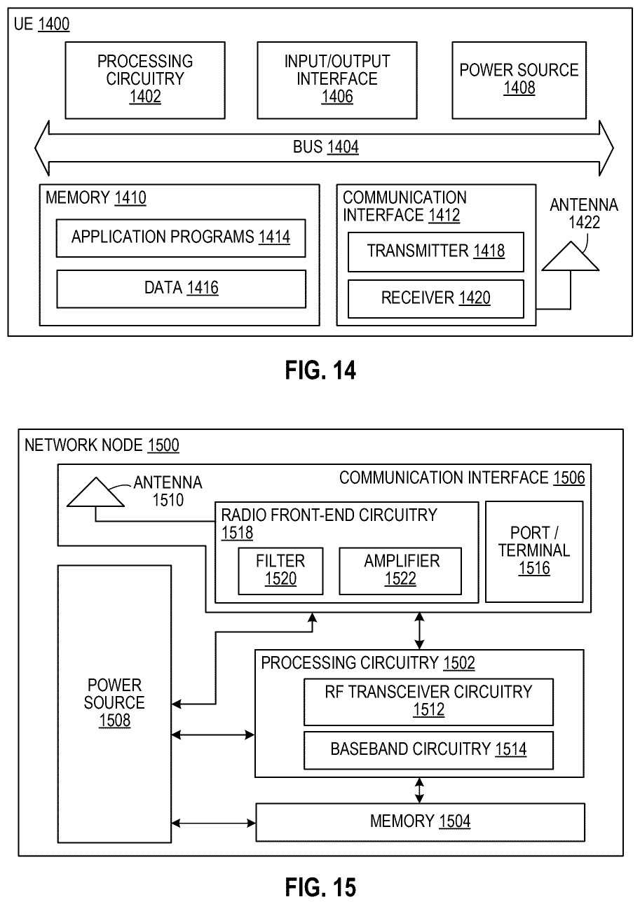

FIG. 14 shows a UE 1400 in accordance with some embodiments. Structures as illustrated in FIG. 14 may for example be used for implementing any of the above UEs 112, 112a, 112b, which may in turn act as the above target UE, reference UE, or SL positioning server UE. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. Structures as illustrated in FIG. 15 may for example be used for implementing any of the above network node, e.g., access nodes 110, 110a, 110b, AMF, LMF, or E-SMLC, which may in turn configure operation of the above target UE, reference UE, or SL positioning server UE. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

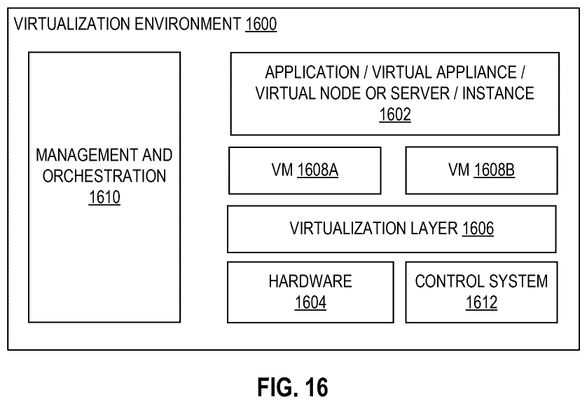

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

### Embodiment 1

A method of positioning a target device-to-device, D2D, communication device (112, 112a, 112b; 1400), the method comprising:
the target D2D communication device (112, 112a, 112b; 1400) receiving D2D signaling from one or more further D2D communication devices; and
based on the received D2D signaling, the target D2D communication device (112, 112a, 112b; 1400) selecting at least one D2D communication device (112, 112a, 112b; 1400) to support positioning of the target D2D communication device.

### Embodiment 2

The method according to embodiment 1,
wherein the received D2D signaling is received in response to D2D signaling sent by the target D2D communication device (112, 112a, 112b; 1400).

### Embodiment 3

The method according to embodiment 2,
wherein the sent D2D signaling comprises an indication that the D2D signaling has the purpose of discovering at least one D2D communication device (112, 112a, 112b; 1400) to support positioning of the target D2D communication device (112, 112a, 112b; 1400).

### Embodiment 4

The method according to embodiment 2 or 3,
wherein the sent D2D signaling indicates one or more quality requirements for the positioning of the target D2D communication device (112, 112a, 112b; 1400).

### Embodiment 5

The method according to any of embodiments 2 to 4,
wherein the sent D2D signaling indicates one or more capabilities of the target D2D communication device (112, 112a, 112b; 1400).

### Embodiment 6

The method according to embodiment 5,
wherein the one or more capabilities comprise one or more D2D positioning methods supported by the target D2D communication device (112, 112a, 112b; 1400).

### Embodiment 7

The method according to any of embodiments 1 to 6,
wherein the selected at least one D2D communication device comprises a D2D communication device to support the positioning of the target D2D communication device (112, 112a, 112b; 1400) by acting as a positioning server.

### Embodiment 8

The method according to embodiment 7,
wherein the target D2D communication device (112, 112a, 112b; 1400) selects the D2D communication device (112, 112a, 112b; 1400) to act as a positioning server based on signal strength from one or more candidate D2D communication devices (112, 112a, 112b; 1400).

### Embodiment 9

The method according to embodiment 7 or 8,
wherein the target D2D communication device (112, 112a, 112b; 1400) selects the D2D communication device (112, 112a, 112b; 1400) to act as a positioning server based on response delay from one or more candidate D2D communication devices (112, 112a, 112b; 1400).

### Embodiment 10

The method according to any one of embodiments 7 to 9,
wherein the target D2D communication device (112, 112a, 112b; 1400) selects the D2D communication device (112, 112a, 112b; 1400) to act as a positioning server based on a number of hops of a connection from the target D2D communication device (112, 112a, 112b; 1400) to one or more candidate D2D communication devices (112, 112a, 112b; 1400).

### Embodiment 11

The method according to any one of embodiments 7 to 10,
wherein the target D2D communication device (112, 112a, 112b; 1400) selects the D2D communication device to act as a positioning server based on distance between the target D2D communication device (112, 112a, 112b; 1400) and one or more candidate D2D communication devices (112, 112a, 112b; 1400).

### Embodiment 12

The method according to any one of embodiments 7 to 11,
wherein the target D2D communication device (112, 112a, 112b; 1400) selects the D2D communication device (112, 112a, 112b; 1400) to act as a positioning server based on positioning related load of one or more candidate D2D communication devices (112, 112a, 112b; 1400).

### Embodiment 13

The method according to any one of embodiments 7 to 12,
wherein the target D2D communication device selects the D2D communication device to act as a positioning server based on battery status of one or more candidate D2D communication devices.

### Embodiment 14

The method according to any one of embodiments 7 to 13,
wherein the target D2D communication device (112, 112a, 112b; 1400) selects the D2D communication device (112, 112a, 112b; 1400) to act as a positioning server based on mobility of one or more candidate D2D communication devices (112, 112a, 112b; 1400).

### Embodiment 15

The method according to any one of embodiments 7 to 14,
wherein the target D2D communication device (112, 112a, 112b; 1400) selects the D2D communication device (112, 112a, 112b; 1400) to act as a positioning server based on a number of neighboring D2D communication devices (112, 112a, 112b; 1400) discovered by each of one or more candidate D2D communication devices (112, 112a, 112b; 1400).

### Embodiment 16

The method according to any one of embodiments 7 to 15,
wherein the target D2D communication device selects the D2D communication device to act as a positioning server based on whether a candidate D2D communication device has a connection to a network node (110, 110a, 110b).

### Embodiment 17

The method according to any one of embodiments 7 to 16,
wherein the target D2D communication device (112, 112a, 112b; 1400) selects the D2D communication device (112, 112a, 112b; 1400) to act as a positioning server based on whether a candidate D2D communication device (112, 112a, 112b; 1400) is capable of supporting positioning of the target D2D communication device (112, 112a, 112b; 1400) in one or more further roles than a positioning server.

### Embodiment 18

The method according to embodiment 17,
wherein the one or more further roles comprise support of positioning of the target D2D communication device (112, 112a, 112b; 1400) by acting as a positioning reference.

### Embodiment 19

The method according to any of embodiments 7 to 18,
wherein the target D2D communication device (112, 112a, 112b; 1400) determines at least one candidate D2D communication device (112, 112a, 112b; 1400) to act as the positioning server based on the D2D signaling received by the target D2D communication device (112, 112a, 112b; 1400).

### Embodiment 20

The method according to any of embodiments 7 to 19,
wherein the target D2D communication device (112, 112a, 112b; 1400) determines at least one candidate D2D communication device (112, 112a, 112b; 1400) to act as the positioning server based on configuration information provided by a network node.

### Embodiment 21

The method according to any of embodiments 7 to 20,
wherein the target D2D communication device (112, 112a, 112b; 1400) determines at least one candidate D2D communication device (112, 112a, 112b; 1400) to act as the positioning server based on preconfiguration of the target D2D communication device (112, 112a, 112b; 1400).

### Embodiment 22

The method according to any of embodiments 7 to 21, comprising:
the target D2D communication device (112, 112a, 112b; 1400) sending, to the D2D communication device (112, 112a, 112b; 1400) selected to act as positioning server, a request to select one or more D2D communication devices (112, 112a, 112b; 1400) to act as positioning reference for the target D2D communication device (112, 112a, 112b; 1400).

### Embodiment 23

The method according to any one of embodiments 1 to 22,
wherein the selected at least one D2D communication device (112, 112a, 112b; 1400) comprises at least one D2D communication device (112, 112a, 112b; 1400) to support the positioning of the target D2D communication device (112, 112a, 112b; 1400) by acting as a positioning reference.

### Embodiment 24

The method according to embodiment 23,
wherein the target D2D communication device (112, 112a, 112b; 1400) selects the D2D communication device to act as a positioning reference based on signal strength from one or more candidate D2D communication devices (112, 112a, 112b; 1400).

### Embodiment 25

The method according to embodiment 23 or 24,
wherein the target D2D communication device (112, 112a, 112b; 1400) selects the D2D communication device (112, 112a, 112b; 1400) to act as a positioning reference based on response delay from one or more candidate D2D communication devices (112, 112a, 112b; 1400).

### Embodiment 26

The method according to any one of embodiments 23 to 25,
wherein the target D2D communication device (112, 112a, 112b; 1400) selects the D2D communication device (112, 112a, 112b; 1400) to act as a positioning reference based on distance between the target D2D communication device and one or more candidate D2D communication devices (112, 112a, 112b; 1400).

### Embodiment 27

The method according to any one of embodiments 23 to 26,
wherein the target D2D communication device (112, 112a, 112b; 1400) selects the D2D communication device (112, 112a, 112b; 1400) to act as a positioning reference based on positioning related load of one or more candidate D2D communication devices (112, 112a, 112b; 1400).

### Embodiment 28

The method according to any one of embodiments 23 to 27,
wherein the target D2D communication device (112, 112a, 112b; 1400) selects the D2D communication device to act as a positioning reference based on one or more positioning methods respectively supported by the one or more candidate D2D communication devices (112, 112a, 112b; 1400).

### Embodiment 29

The method according to any one of embodiments 22 to 27,
wherein the target D2D communication device (112, 112a, 112b; 1400) selects the D2D communication device (112, 112a, 112b; 1400) to act as a positioning reference based on a set of neighboring D2D communication devices (112, 112a, 112b; 1400) of a D2D communication device supporting positioning of the target D2D communication device (112, 112a, 112b; 1400) as a positioning server.

### Embodiment 30

The method according to embodiment 29,
wherein the target D2D communication device (112, 112a, 112b; 1400) selects the D2D communication device (112, 112a, 112b; 1400) to act as a positioning reference based on whether a candidate D2D communication device (112, 112a, 112b; 1400) is part of a set of neighboring D2D communication devices (112, 112a, 112b; 1400) of a D2D communication device (112, 112a, 112b; 1400) supporting positioning of the target D2D communication device (112, 112a, 112b; 1400) as a positioning server.

### Embodiment 31

The method according to embodiment 29 or 30, comprising:
the target D2D communication device (112, 112a, 112b; 1400) receiving an indication of the set of neighboring D2D communication devices (112, 112a, 112b; 1400) from the D2D communication device (112, 112a, 112b; 1400) supporting positioning of the target D2D communication device (112, 112a, 112b; 1400) as a positioning server.

### Embodiment 32

The method according to embodiment 29 or 30, comprising:
the target D2D communication device (112, 112a, 112b; 1400) enquiring the D2D communication device (112, 112a, 112b; 1400) supporting positioning of the target D2D communication device (112, 112a, 112b; 1400) as a positioning server whether a candidate D2D communication device (112, 112a, 112b; 1400) is part of the set of neighboring D2D communication devices (112, 112a, 112b; 1400).

### Embodiment 33

The method according to any of embodiments 1 to 32,
wherein the D2D communication is based on a sidelink, SL, interface of the New Radio, NR, technology.

### Embodiment 34

The method according to embodiment 32,
wherein the D2D signaling comprises one or more of SL positioning signaling, SL discovery signaling, non-access stratum signaling via the SL interface, radio resource control, RRC, signaling via the SL interface, Medium Access Control, MAC, signaling via the SL interface, and SL physical layer signaling.

### Embodiment 35

A method of positioning a target D2D communication device (112, 112a, 112b; 1400), the method comprising:

a D2D communication device (112, 112a, 112b; 1400) sending D2D signaling indicating at least one capability of the D2D communication device (112, 112a, 112b; 1400) to support positioning of a target D2D communication device (112, 112a, 112b; 1400).

### Embodiment 36

The method according to embodiment 35,
wherein the D2D communication device (112, 112a, 112b; 1400) sends the D2D signaling in response to receiving D2D signaling from the target D2D communication device (112, 112a, 112b; 1400).

### Embodiment 37

The method according to embodiment 36,
wherein the D2D signaling received from the target D2D communication device (112, 112a, 112b; 1400) comprises an indication that the D2D signaling has the purpose of discovering at least one D2D communication device (112, 112a, 112b; 1400) to support positioning of the target D2D communication device (112, 112a, 112b; 1400).

### Embodiment 38

The method according to embodiment 36 or 37,
wherein the D2D signaling received from the target D2D communication device (112, 112a, 112b; 1400) indicates one or more quality requirements for the positioning of the target D2D communication device (112, 112a, 112b; 1400).

### Embodiment 39

The method according to any of embodiments 36 to 38,
wherein the D2D signaling received from the target D2D communication device (112, 112a, 112b; 1400) indicates one or more capabilities of the target D2D communication device (112, 112a, 112b; 1400).

### Embodiment 40

The method according to embodiment 39,
wherein the one or more capabilities comprise one or more D2D positioning methods supported by the target D2D communication device (112, 112a, 112b; 1400).

### Embodiment 41

The method according to any of embodiments 35 to 40,
wherein the at least one capability of the D2D communication device (112, 112a, 112b; 1400) comprises a capability to act as a positioning server.

### Embodiment 42

The method according to embodiment 41,
wherein the D2D signaling sent by the D2D communication device (112, 112a, 112b; 1400) enables the target D2D communication device (112, 112a, 112b; 1400) to determine a signal strength from the D2D communication device (112, 112a, 112b; 1400).

### Embodiment 43

The method according to embodiment 41 or 42,
wherein the D2D signaling sent by the D2D communication device (112, 112a, 112b; 1400) enables the target D2D communication device (112, 112a, 112b; 1400) to determine a response delay from the D2D communication device (112, 112a, 112b; 1400).

### Embodiment 44

The method according to any one of embodiments 41 to 43,
wherein the D2D signaling sent by the D2D communication device (112, 112a, 112b; 1400) enables the target D2D communication device (112, 112a, 112b; 1400) to determine a number of hops of a connection from the target D2D communication device (112, 112a, 112b; 1400) to the D2D communication device (112, 112a, 112b; 1400).

### Embodiment 45

The method according to any one of embodiments 41 to 44,
wherein the D2D signaling sent by the D2D communication device (112, 112a, 112b; 1400) enables the target D2D communication device to determine a distance between the target D2D communication device (112, 112a, 112b; 1400) and the D2D communication device (112, 112a, 112b; 1400).

### Embodiment 46

The method according to any one of embodiments 41 to 45,
wherein the D2D signaling sent by the D2D communication device (112, 112a, 112b; 1400) indicates a positioning related load of the D2D communication device (112, 112a, 112b; 1400).

### Embodiment 47

The method according to any one of embodiments 41 to 46,
wherein the D2D signaling sent by the D2D communication device (112, 112a, 112b; 1400) indicates battery status of the D2D communication device (112, 112a, 112b; 1400).

### Embodiment 48

The method according to any one of embodiments 41 to 47,
wherein the D2D signaling sent by the D2D communication device (112, 112a, 112b; 1400) enables the target D2D communication device (112, 112a, 112b; 1400) to determine mobility of the D2D communication device (112, 112a, 112b; 1400).

### Embodiment 49

The method according to any one of embodiments 41 to 48,
wherein the D2D signaling sent by the D2D communication device (112, 112a, 112b; 1400) indicates neighboring D2D communication devices (112, 112a, 112b; 1400) discovered the D2D communication device (112, 112a, 112b; 1400).

### Embodiment 50

The method according to embodiment 49,
wherein the D2D signaling sent by the D2D communication device (112, 112a, 112b; 1400) indicates a number of the neighboring D2D communication devices (112, 112a, 112b; 1400) discovered the D2D communication device (112, 112a, 112b; 1400).

### Embodiment 51

The method according to embodiment 49 or 50,
wherein the D2D signaling sent by the D2D communication device (112, 112a, 112b; 1400) indicates respective positioning related capabilities of the neighboring D2D communication devices (112, 112a, 112b; 1400) discovered the D2D communication device (112, 112a, 112b; 1400).

### Embodiment 52

The method according to any one of embodiments 41 to 51,
wherein the D2D signaling sent by the D2D communication device indicates whether the D2D communication device has a connection to a network node.

### Embodiment 53

The method according to any one of embodiments 41 to 52,
wherein the D2D signaling sent by the D2D communication device (112, 112a, 112b; 1400) indicates whether the D2D communication device (112, 112a, 112b; 1400) is capable of supporting positioning of the target D2D communication device (112, 112a, 112b; 1400) in one or more further roles than a positioning server.

### Embodiment 54

The method according to embodiment 53,
wherein the one or more further roles comprise support of positioning of the target D2D communication device (112, 112a, 112b; 1400) by acting as a positioning reference.

### Embodiment 55

The method according to any of embodiments 41 to 54, comprising:
in response to the D2D communication device (112, 112a, 112b; 1400) being selected as positioning server for the target D2D communication device (112, 112a, 112b; 1400), the D2D communication device receiving, from the target D2D communication device (112, 112a, 112b; 1400), a request to select one or more D2D communication devices (112, 112a, 112b; 1400) to act as positioning reference for the target D2D communication device (112, 112a, 112b; 1400); and
in response to the request, the D2D communication device (112, 112a, 112b; 1400) selecting at least one D2D communication device (112, 112a, 112b; 1400) to act as positioning reference for the target D2D communication device (112, 112a, 112b; 1400).

### Embodiment 56

The method according to any one of embodiments 35 to 55,
wherein the at least one capability of the D2D communication device (112, 112a, 112b; 1400) comprises a capability to act as a positioning reference.

### Embodiment 57

The method according to embodiment 56,
wherein the D2D signaling sent by the D2D communication device (112, 112a, 112b; 1400) indicates on one or more positioning methods supported by the D2D communication device (112, 112a, 112b; 1400).

### Embodiment 58

The method according to any of embodiments 35 to 57,
wherein the D2D communication is based on an SL interface of the NR technology.

### Embodiment 59

The method according to embodiment 58,
wherein the D2D signaling comprises one or more of SL positioning signaling, SL discovery signaling, non-access stratum signaling via the SL interface, RRC signaling via the SL interface, MAC signaling via the SL interface, and SL physical layer signaling.

### Group B Embodiments

### Embodiment 60

A method of positioning a target D2D communication device (112, 112a, 112b; 1400), the method comprising:
a network node (110, 110a, 110b, 1500) configuring the target D2D communication device (112, 112a, 112b; 1400) to operate according to a method of any of embodiments 1 to 34.

### Embodiment 61

A method of positioning a target D2D communication device, the method comprising:
a network node (110, 110a, 110b, 1500) configuring a D2D communication device (112, 112a, 112b; 1400) to operate according to a method of any of embodiments 35 to 59.

### Group C Embodiments

### Embodiment 62

A D2D communication device (112, 112a, 112b; 1400), the D2D communication device (112, 112a, 112b; 1400) being adapted to:
receive D2D signaling from one or more further D2D communication devices (112, 112a, 112b; 1400); and
based on the received D2D signaling, the D2D communication device (112, 112a, 112b; 1400) selecting at least one D2D communication device to support positioning of the D2D communication device (112, 112a, 112b; 1400).

### Embodiment 63

The D2D communication device (112, 112a, 112b; 1400) according to embodiment 62,
wherein the D2D communication device (112, 112a, 112b; 1400) is adapted to perform a method according to any one of embodiments 2 to 31.

### Embodiment 64

The D2D communication device (112, 112a, 112b; 1400) according to embodiment 62 or 63, comprising:
processing circuitry (1402), and
a memory (1410) containing program code executable by the processing circuitry (1402),
whereby execution of the program code by the processing circuitry (1402) causes the D2D communication device (112, 112a, 112b; 1400) to perform a method according to any one of embodiments 1 to 34.

### Embodiment 65

A D2D communication device (112, 112a, 112b; 1400), the D2D communication device (112, 112a, 112b; 1400) being adapted to:
send D2D signaling indicating at least one capability of the D2D communication device (112, 112a, 112b; 1400) to support positioning of a target D2D communication device (112, 112a, 112b; 1400).

### Embodiment 66

The D2D communication device (112, 112a, 112b; 1400) according to embodiment 65,
wherein the D2D communication device (112, 112a, 112b; 1400) is adapted to perform a method according to any one of embodiments 36 to 59.

### Embodiment 67

The D2D communication device (112, 112a, 112b; 1400) according to embodiment 65 or 66, comprising:
processing circuitry (1402), and
a memory (1410) containing program code executable by the processing circuitry (1402),
whereby execution of the program code by the processing circuitry (1402) causes the D2D communication device (112, 112a, 112b; 1400) to perform a method according to any one of embodiments 35 to 59.

### Embodiment 68

A network node (110, 110a, 110b; 1500), the network node (110, 110a, 110b; 1500) being adapted to configure a target D2D communication device (112, 112a, 112b; 1400) to operate according to a method of any of embodiments 1 to 59.

### Embodiment 69

A network node (110, 110a, 110b; 1500), the network node comprising:
processing circuitry (1502), and
a memory (1504) containing program code executable by the processing circuitry (1502),
whereby execution of the program code by the processing circuitry (1502) causes the network node to configure a D2D communication device (112, 112a, 112b; 1400) to operate according to a method of any of embodiments 1 to 59.

### Embodiment 70

A computer program or computer program product comprising program code to be executed by processing circuitry (1402) of a D2D communication device (112, 112a, 112b; 1400), whereby execution of the program code causes the D2D communication device (112, 112a, 112b; 1400) to perform a method according to any one of the Group A embodiments.

### Embodiment 71

A computer program or computer program product comprising program code to be executed by processing circuitry (1502) of a network node, whereby execution of the program code causes the network node (110, 110a, 110b; 1500) to perform a method according to any one of the Group B embodiments.

1. A method of positioning a target user equipment, UE, the method comprising:
a UE sending sidelink, SL, signaling indicating at least one capability of the UE to support positioning of a target UE in a role of an SL positioning server UE and/or in a role of an anchor UE.

2. The method according to claim 1,
wherein the UE sends the SL signaling in response to receiving SL signaling from the target UE.

3. The method according to claim 2,
wherein the SL signaling received from the target UE comprises an indication that the SL signaling has the purpose of discovering at least one UE to support positioning of the target UE.

4. The method according to claim 2,
wherein the SL signaling received from the target UE indicates one or more quality requirements for the positioning of the target UE.

5-8. (canceled)

9. The method according to any one of the preceding claims claim 1,
wherein the SL signaling sent by the UE indicates neighboring UEs discovered by the UE.

10-12. (canceled)

13. The method according to any one of the preceding claims claim 1, comprising:
in response to the UE being selected as SL positioning server UE for the target UE, the UE receiving, from the target UE, a request to select one or more UEs to act as anchor UE for the target UE; and
in response to the request, the UE selecting at least one UE to act as anchor UE for the target UE.

14. The method according to any one of the preceding claims claim 1,
wherein the SL signaling sent by the UE indicates one or more positioning methods supported by the UE.

15-17. (canceled)

18. A method of positioning a target UE, the method comprising:
the target UE receiving SL signaling from one or more further UEs, the received SL signaling indicating at least one capability of the further UE to support positioning of the target UE in a role of an SL positioning server UE and/or in a role of an anchor UE; and
based on the received SL signaling, the target UE selecting at least one UE to support positioning of the target UE device.

19-20. (canceled)

21. The method according to any one of claims 18 to 20 claim 18,
wherein the SL signaling received by the target UE indicates neighboring UEs discovered by the further UE.

22. The method according to claim 21,
wherein the SL signaling received by the target UE indicates a number of the neighboring UEs discovered by the further UE.

23. The method according to claim 21,
wherein the SL signaling received by the target UE indicates respective positioning related capabilities of the neighboring UEs discovered by the further UE.

24. (canceled)

25. The method according to any one of claims 18 to 22 claim 18,
wherein the SL signaling received by the target UE indicates one or more positioning methods supported by the further UE.

26-36. (canceled)

37. A method of positioning a target UE, the method comprising:
a UE sending SL signaling to one or more further UEs,
wherein the SL signaling comprises an indication that the SL signaling has the purpose of discovering at least one UE to support positioning of a target UE in the role of an SL positioning server UE and/or has the purpose of discovering at least one UE to support positioning of the target UE in the role of an anchor UE.

38. The method according to claim 37,
wherein the SL signaling indicates one or more quality requirements for the positioning of the target UE.

39-41. (canceled)

42. A UE, the UE being adapted to:
send SL signaling indicating at least one capability of the UE to support positioning of a target UE in a role of an SL positioning server UE and/or in a role of an anchor UE.

43. The UE according to claim 42,
wherein the UE sends the SL signaling in response to receiving SL signaling from the target UE, and wherein the SL signaling received from the target UE comprises an indication that the SL signaling has the purpose of discovering at least one UE to support positioning of the target UE.

44-51. (canceled)
